(19) United States
(12) Patent Application Publication
(10) Pub. No.: US 2026/0020014 A1
(43) Pub. Date: Jan. 15, 2026

(54) TECHNIQUES FOR DECODING SIDELINK CONTROL INFORMATION FOR RETRANSMISSIONS

(71) Applicant: QUALCOMM Incorporated, San Diego, CA (US)

(72) Inventors: Zhichao ZHOU, Beijing (CN); Seyedkianoush HOSSEINI, San Diego, CA (US); Ovidiu Constantin IACOBOAIEA, Chatillon (FR)

(21) Appl. No.: 18/992,919

(22) PCT Filed: Aug. 19, 2022
(86) PCT No.: PCT/CN2022/113507

§ 371 Date: Jan. 9, 2025

(51) Int. Cl. H04W 72/1263

(52) U.S. Cl. CPC H04W 72/1263

(57) ABSTRACT

Methods, systems, and devices for wireless communications are described. A user equipment (UE) may receive a configuration for monitoring resources from a resource pool, where the resources may be associated with a respective group of UEs. In some examples, the configuration may indicate a pattern of resources, the pattern indicating an ordering of subchannels for retransmissions of downlink data. The UE may broadcast a feedback message based on failing to decode downlink data and may monitor a first subset of resources for sidelink control information (SCI) based on the configuration or the pattern and based on broadcasting the feedback message. The UE may receive, from a second UE and via the first subset of resources, a sidelink message comprising the SCI based on the monitoring, where the SCI may indicate a sidelink data channel for a retransmission of the downlink data.

### CROSS REFERENCE

The present application is a 371 national stage filing of International PCT Application No. PCT/CN2022/113507 by ZHOU et al. entitled “TECHNIQUES FOR DECODING SIDELINK CONTROL INFORMATION FOR RETRANSMISSIONS,” filed Aug. 19, 2022, which is assigned to the assignee hereof, and which is expressly incorporated by reference in its entirety herein.

### FIELD OF TECHNOLOGY

The following relates to wireless communications, including techniques for decoding sidelink control information for retransmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for decoding sidelink control information (SCI) for downlink data retransmissions. For example, the described techniques provide for increased reliability, decreased latency, and decreased power consumption in wireless communications systems supporting high-reliability applications, such as extended reality (XR) applications in which user equipment (UEs) may communicate via sidelink communications. Such wireless communications systems may support groupcasting configurations, where UEs may broadcast or groupcast communications to other UEs in a group, which may include groupcasting feedback for a downlink message. In some examples, the UEs may support retransmission (e.g., within the group) of downlink messages unsuccessfully received from a network entity by another UE, which may enable relatively more efficient use of system resources.

For example, a UE may receive a downlink message from a network entity and may retransmit the downlink message to one or more other UEs that failed to receive or decode the downlink message using sidelink resources. However, in some sidelink communications, an intended recipient of the sidelink message may blind decode control information (e.g., SCI) in the sidelink message to identify resources for receiving a sidelink communication including the downlink data, where such blind decoding may increase processing time and power consumption and may inhibit XR applications which rely on fast and reliable communications to provide a satisfactory user experience.

To decrease blind decoding inefficiencies, a network entity may transmit a resource configuration to each UE of a group, where the resource configuration may assign or map some sets of resources over which a retransmitting UE may transmit control information for a corresponding data transmission (e.g., including retransmission data). Additionally, or alternatively, the resource configuration may indicate a pattern of resources over which a transmitting UE may transmit the control information based on an availability of each resource in the pattern. Thus, based on the resource configuration, a receiving UE may more efficiently identify resources to monitor for control information associated with the retransmission, thereby decreasing reliance on blind decoding. Likewise, in cases where blind decoding is performed, the receiving UE may have a relatively reduced set of resources on which control information may be transmitted, thereby decreasing time and energy spent blind decoding.

A method for wireless communications at a first UE is described. The method may include receiving a message indicating a configuration for monitoring one or more subsets of resources from a resource pool, the one or more subsets of resources being associated with a respective UE group of one or more UE groups, broadcasting, to two or more UEs, a feedback message based on failing to decode a downlink transmission including downlink data, monitoring a first subset of resources of the one or more subsets of resources for sidelink control information based on the configuration and broadcasting the feedback message, and receiving, from a second UE and via the first subset of resources, a sidelink message including the sidelink control information based on the monitoring, the sidelink control information indicating a sidelink data channel for a retransmission of the downlink data based on the feedback message, the first subset of resources corresponding to a first UE group that includes the second UE.

An apparatus for wireless communications at a first UE is described. The apparatus may include a processor, memory coupled with the processor, and instructions stored in the memory. The instructions may be executable by the processor to cause the apparatus to receive a message indicating a configuration for monitoring one or more subsets of resources from a resource pool, the one or more subsets of resources being associated with a respective UE group of one or more UE groups, broadcasting, to two or more UEs, a feedback message base at least in part on failing to decode a downlink transmission including downlink data, monitor a first subset of resources of the one or more subsets of resources for sidelink control information based on the configuration and broadcasting the feedback message, and receive, from a second UE and via the first subset of resources, a sidelink message including the sidelink control information based on the monitoring, the sidelink control information indicating a sidelink data channel for a retransmission of the downlink data based on the feedback message, the first subset of resources corresponding to a first UE group that includes the second UE.

Another apparatus for wireless communications at a first UE is described. The apparatus may include means for receiving a message indicating a configuration for monitoring one or more subsets of resources from a resource pool, the one or more subsets of resources being associated with a respective UE group of one or more UE groups, means for broadcasting, to two or more UEs, a feedback message based on failing to decode a downlink transmission including downlink data, means for monitoring a first subset of resources of the one or more subsets of resources for sidelink control information based on the configuration and broadcasting the feedback message, and means for receiving, from a second UE and via the first subset of resources, a sidelink message including the sidelink control information based on the monitoring, the sidelink control information indicating a sidelink data channel for a retransmission of the downlink data based on the feedback message, the first subset of resources corresponding to a first UE group that includes the second UE.

A non-transitory computer-readable medium storing code for wireless communications at a first UE is described. The code may include instructions executable by a processor to receive a message indicating a configuration for monitoring one or more subsets of resources from a resource pool, the one or more subsets of resources being associated with a respective UE group of one or more UE groups, broadcasting, to two or more UEs, a feedback message base at least in part on failing to decode a downlink transmission including downlink data, monitor a first subset of resources of the one or more subsets of resources for sidelink control information based on the configuration and broadcasting the feedback message, and receive, from a second UE and via the first subset of resources, a sidelink message including the sidelink control information based on the monitoring, the sidelink control information indicating a sidelink data channel for a retransmission of the downlink data based on the feedback message, the first subset of resources corresponding to a first UE group that includes the second UE.

In some examples of the method, apparatuses, and non-transitory computer-readable medium described herein, monitoring the first subset of resources may include operations, features, means, or instructions for monitoring a first subchannel associated with the second UE for the sidelink control information.

In some examples of the method, apparatuses, and non-transitory computer-readable medium described herein, the configuration further indicates a mapping between each UE of the first UE group and a respective subchannel of the set of multiple subchannels and receiving the sidelink message may be based on the mapping.

Some examples of the method, apparatuses, and non-transitory computer-readable medium described herein may further include operations, features, means, or instructions for receiving, from a third UE, a second sidelink message indicating the retransmission of the downlink data will be received from the second UE, where the third UE includes a primary UE of the first UE group.

In some examples of the method, apparatuses, and non-transitory computer-readable medium described herein, the first subset of resources includes a set of subchannels that may be associated with the second UE.

In some examples of the method, apparatuses, and non-transitory computer-readable medium described herein, each UE group of the one or more UE groups includes a set of multiple UEs and each UE of a UE group may be configured with a downlink communication beam having a beam direction that may be within a threshold beam direction with respect to other downlink communication beam directions of other UEs included in the UE group.

In some examples of the method, apparatuses, and non-transitory computer-readable medium described herein, the configuration further indicates a relative priority of each UE of a respective UE group and the method, apparatuses, and non-transitory computer-readable medium may include further operations, features, means, or instructions for determining that the second UE may have a higher priority than a third UE based on the configuration, where receiving the sidelink message via the first subset of resources from the second UE may be based on the higher priority.

Some examples of the method, apparatuses, and non-transitory computer-readable medium described herein may further include operations, features, means, or instructions for decoding the sidelink control information communicated via the one or more subsets of resources indicated by the configuration.

Some examples of the method, apparatuses, and non-transitory computer-readable medium described herein may further include operations, features, means, or instructions for receiving the sidelink message via the first subset of resources during a time period precludes other UEs of the first UE group from communicating via the first subset of resources during the time period.

In some examples of the method, apparatuses, and non-transitory computer-readable medium described herein, the two or more UEs include a UE group that may be associated with the first UE.

In some examples of the method, apparatuses, and non-transitory computer-readable medium described herein, each UE group of the one or more UE groups may be associated with a single subset of resources.

A method for wireless communication at a first UE is described. The method may include receiving a message indicating a configuration for monitoring one or more resources in accordance with a pattern of resources, the pattern of resources indicating an ordering of respective subchannels of a set of multiple subchannels for retransmissions of downlink data via a sidelink data channel, broadcasting, to two or more UEs, a feedback message based on failing to decode a downlink transmission including the downlink data, monitoring, in accordance with the ordering, one or more subchannels of the set of multiple subchannels for sidelink control information based on the configuration and broadcasting the feedback message, and receiving, from a second UE, a sidelink message including the sidelink control information based on the monitoring, the sidelink control information indicating a sidelink data channel for a retransmission of the downlink data based on the feedback message.

An apparatus for wireless communication at a first UE is described. The apparatus may include a processor, memory coupled with the processor, and instructions stored in the memory. The instructions may be executable by the processor to cause the apparatus to receive a message indicating a configuration for monitoring one or more resources in accordance with a pattern of resources, the pattern of resources indicating an ordering of respective subchannels of a set of multiple subchannels for retransmissions of downlink data via a sidelink data channel, broadcasting, to two or more UEs, a feedback message base at least in part on failing to decode a downlink transmission including the downlink data, monitor, in accordance with the ordering, one or more subchannels of the set of multiple subchannels for sidelink control information based on the configuration and broadcasting the feedback message, and receive, from a second UE, a sidelink message including the sidelink control information based on the monitoring, the sidelink control information indicating a sidelink data channel for a retransmission of the downlink data based on the feedback message.

Another apparatus for wireless communication at a first UE is described. The apparatus may include means for receiving a message indicating a configuration for monitoring one or more resources in accordance with a pattern of resources, the pattern of resources indicating an ordering of respective subchannels of a set of multiple subchannels for retransmissions of downlink data via a sidelink data channel, means for broadcasting, to two or more UEs, a feedback message based on failing to decode a downlink transmission including the downlink data, means for monitoring, in accordance with the ordering, one or more subchannels of the set of multiple subchannels for sidelink control information based on the configuration and broadcasting the feedback message, and means for receiving, from a second UE, a sidelink message including the sidelink control information based on the monitoring, the sidelink control information indicating a sidelink data channel for a retransmission of the downlink data based on the feedback message.

A non-transitory computer-readable medium storing code for wireless communication at a first UE is described. The code may include instructions executable by a processor to receive a message indicating a configuration for monitoring one or more resources in accordance with a pattern of resources, the pattern of resources indicating an ordering of respective subchannels of a set of multiple subchannels for retransmissions of downlink data via a sidelink data channel, broadcasting, to two or more UEs, a feedback message base at least in part on failing to decode a downlink transmission including the downlink data, monitor, in accordance with the ordering, one or more subchannels of the set of multiple subchannels for sidelink control information based on the configuration and broadcasting the feedback message, and receive, from a second UE, a sidelink message including the sidelink control information based on the monitoring, the sidelink control information indicating a sidelink data channel for a retransmission of the downlink data based on the feedback message.

In some examples of the method, apparatuses, and non-transitory computer-readable medium described herein, monitoring the one or more subchannels may include operations, features, means, or instructions for monitoring a first set of subchannels of the set of multiple subchannels according to the pattern and determining whether the first set of subchannels includes the sidelink control information based on the monitoring.

Some examples of the method, apparatuses, and non-transitory computer-readable medium described herein may further include operations, features, means, or instructions for monitoring a second set of subchannels of the set of multiple subchannels according to the pattern based on an absence of the sidelink control information in the first set of subchannels.

Some examples of the method, apparatuses, and non-transitory computer-readable medium described herein may further include operations, features, means, or instructions for detecting the sidelink control information based on monitoring the second set of subchannels and decoding the sidelink control information communicated via the second set of subchannels, where the first set of subchannels may have a higher priority than the second set of subchannels.

Some examples of the method, apparatuses, and non-transitory computer-readable medium described herein may further include operations, features, means, or instructions for transmitting, to a third UE via the first set of subchannels or the second set of subchannels, a second sidelink message including second sidelink control information, the second sidelink control information indicating a second sidelink data channel for a retransmission of second downlink data.

In some examples of the method, apparatuses, and non-transitory computer-readable medium described herein, each subchannel of the set of multiple subchannels may be associated with a respective priority relative to other subchannels of the set of multiple subchannels.

In some examples of the method, apparatuses, and non-transitory computer-readable medium described herein, a subchannel of the set of multiple subchannels may be dedicated to sidelink communications associated with a threshold priority and the one or more subchannels include remaining subchannels of the set of multiple subchannels.

A method for wireless communications at a first UE is described. The method may include receiving a message indicating a configuration for transmissions using one or more subsets of resources from a resource pool, the one or more subsets of resources being associated with a respective UE group of one or more UE groups, receiving, from a second UE, a feedback message indicating the second UE failed to decode a downlink transmission including downlink data, and transmitting, to the second UE via a first subset of resources, a sidelink message including sidelink control information based on the configuration and receiving the feedback message, the sidelink control information indicating a sidelink data channel for a retransmission of the downlink data, the first subset of resources corresponding to a first UE group that includes the second UE.

An apparatus for wireless communications at a first UE is described. The apparatus may include a processor, memory coupled with the processor, and instructions stored in the memory. The instructions may be executable by the processor to cause the apparatus to receive a message indicating a configuration for transmissions using one or more subsets of resources from a resource pool, the one or more subsets of resources being associated with a respective UE group of one or more UE groups, receive, from a second UE, a feedback message indicating the second UE failed to decode a downlink transmission including downlink data, and transmit, to the second UE via a first subset of resources, a sidelink message including sidelink control information based on the configuration and receiving the feedback message, the sidelink control information indicating a sidelink data channel for a retransmission of the downlink data, the first subset of resources corresponding to a first UE group that includes the second UE.

Another apparatus for wireless communications at a first UE is described. The apparatus may include means for receiving a message indicating a configuration for transmissions using one or more subsets of resources from a resource pool, the one or more subsets of resources being associated with a respective UE group of one or more UE groups, means for receiving, from a second UE, a feedback message indicating the second UE failed to decode a downlink transmission including downlink data, and means for transmitting, to the second UE via a first subset of resources, a sidelink message including sidelink control information based on the configuration and receiving the feedback message, the sidelink control information indicating a sidelink data channel for a retransmission of the downlink data, the first subset of resources corresponding to a first UE group that includes the second UE.

A non-transitory computer-readable medium storing code for wireless communications at a first UE is described. The code may include instructions executable by a processor to receive a message indicating a configuration for transmissions using one or more subsets of resources from a resource pool, the one or more subsets of resources being associated with a respective UE group of one or more UE groups, receive, from a second UE, a feedback message indicating the second UE failed to decode a downlink transmission including downlink data, and transmit, to the second UE via a first subset of resources, a sidelink message including sidelink control information based on the configuration and receiving the feedback message, the sidelink control information indicating a sidelink data channel for a retransmission of the downlink data, the first subset of resources corresponding to a first UE group that includes the second UE.

Some examples of the method, apparatuses, and non-transitory computer-readable medium described herein may further include operations, features, means, or instructions for determining, based on the configuration, which subset of the one or more subsets of resources may be associated with the first UE, where transmitting the sidelink message includes and transmitting the sidelink message via the determined subset of resources.

In some examples of the method, apparatuses, and non-transitory computer-readable medium described herein, transmitting the sidelink control information via the first subset of resources may include operations, features, means, or instructions for transmitting the sidelink control information via a first subchannel associated with the second UE.

Some examples of the method, apparatuses, and non-transitory computer-readable medium described herein may further include operations, features, means, or instructions for transmitting the sidelink message via the first subset of resources during a time period precludes other UEs of the first UE group from communicating via the first subset of resources during the time period.

In some examples of the method, apparatuses, and non-transitory computer-readable medium described herein, the configuration further indicates a relative priority of each UE of a respective UE group and the method, apparatuses, and non-transitory computer-readable medium may include further operations, features, means, or instructions for determining that the second UE may have a higher priority than a third UE that failed to decode the downlink transmission based on the configuration, where transmitting the sidelink message via the first subset of resources to the second UE may be based on the higher priority.

Some examples of the method, apparatuses, and non-transitory computer-readable medium described herein may further include operations, features, means, or instructions for receiving, from a third UE, a second sidelink message indicating the retransmission of the downlink data will be transmitted by the first UE via a subset of resources associated with the first UE, where the third UE may be a primary UE of the first UE group and transmitting the sidelink message may be based on receiving the second sidelink message and transmitting, to the second UE, the sidelink data channel including the retransmission of the downlink data based on receiving the second sidelink message.

Some examples of the method, apparatuses, and non-transitory computer-readable medium described herein may further include operations, features, means, or instructions for transmitting, to a third UE, a second sidelink message indicating the retransmission of the downlink data will be transmitted by the third UE, where the first UE may be a primary UE of the first UE group.

In some examples of the method, apparatuses, and non-transitory computer-readable medium described herein, each UE group of the one or more UE groups may be associated with a single subset of resources.

In some examples of the method, apparatuses, and non-transitory computer-readable medium described herein, the single subset of resources includes a single subchannel.

A method for wireless communication at a first UE is described. The method may include receiving a message indicating a configuration for sidelink transmissions in accordance with a pattern of resources, the pattern of resources indicating an ordering of respective subchannels of a set of multiple subchannels for retransmissions of downlink data via a sidelink data channel, receiving, from a second UE, a feedback message indicating the second UE failed to decode a downlink transmission including the downlink data, transmitting, in response to receiving the feedback message and in accordance with the ordering, sidelink control information via one or more subchannels of the set of multiple subchannels based on receiving the feedback message and the configuration, the sidelink control information indicating a sidelink data channel for a retransmission of the downlink data, and transmitting, to the second UE, the sidelink data channel including the retransmission of the downlink data based on transmitting the sidelink control information.

An apparatus for wireless communication at a first UE is described. The apparatus may include a processor, memory coupled with the processor, and instructions stored in the memory. The instructions may be executable by the processor to cause the apparatus to receive a message indicating a configuration for sidelink transmissions in accordance with a pattern of resources, the pattern of resources indicating an ordering of respective subchannels of a set of multiple subchannels for retransmissions of downlink data via a sidelink data channel, receive, from a second UE, a feedback message indicating the second UE failed to decode a downlink transmission including the downlink data, transmit, in response to receiving the feedback message and in accordance with the ordering, sidelink control information via one or more subchannels of the set of multiple subchannels based on receiving the feedback message and the configuration, the sidelink control information indicating a sidelink data channel for a retransmission of the downlink data, and transmit, to the second UE, the sidelink data channel including the retransmission of the downlink data based on transmitting the sidelink control information.

Another apparatus for wireless communication at a first UE is described. The apparatus may include means for receiving a message indicating a configuration for sidelink transmissions in accordance with a pattern of resources, the pattern of resources indicating an ordering of respective subchannels of a set of multiple subchannels for retransmissions of downlink data via a sidelink data channel, means for receiving, from a second UE, a feedback message indicating the second UE failed to decode a downlink transmission including the downlink data, means for transmitting, in response to receiving the feedback message and in accordance with the ordering, sidelink control information via one or more subchannels of the set of multiple subchannels based on receiving the feedback message and the configuration, the sidelink control information indicating a sidelink data channel for a retransmission of the downlink data, and means for transmitting, to the second UE, the sidelink data channel including the retransmission of the downlink data based on transmitting the sidelink control information.

A non-transitory computer-readable medium storing code for wireless communication at a first UE is described. The code may include instructions executable by a processor to receive a message indicating a configuration for sidelink transmissions in accordance with a pattern of resources, the pattern of resources indicating an ordering of respective subchannels of a set of multiple subchannels for retransmissions of downlink data via a sidelink data channel, receive, from a second UE, a feedback message indicating the second UE failed to decode a downlink transmission including the downlink data, transmit, in response to receiving the feedback message and in accordance with the ordering, sidelink control information via one or more subchannels of the set of multiple subchannels based on receiving the feedback message and the configuration, the sidelink control information indicating a sidelink data channel for a retransmission of the downlink data, and transmit, to the second UE, the sidelink data channel including the retransmission of the downlink data based on transmitting the sidelink control information.

Some examples of the method, apparatuses, and non-transitory computer-readable medium described herein may further include operations, features, means, or instructions for sensing a first subchannel of the set of multiple subchannels according the pattern and determining whether the first subchannel may be available for the retransmission, where transmitting the sidelink control information may be based on the determining.

Some examples of the method, apparatuses, and non-transitory computer-readable medium described herein may further include operations, features, means, or instructions for sensing a second subchannel of the set of multiple subchannels according to the pattern based on determining the first subchannel may be unavailable and determining the second subchannel may be available for the retransmission, where transmitting the sidelink control information may be based on the determining.

### BRIEF DESCRIPTION OF THE DRAWINGS

FIG. 1 illustrates an example of a wireless communications system that supports techniques for decoding sidelink control information for retransmissions in accordance with one or more aspects of the present disclosure.

FIG. 2 illustrates an example of a wireless communications system that supports techniques for decoding sidelink control information for retransmissions in accordance with one or more aspects of the present disclosure.

FIGS. 3A and 3B each illustrate an example of a resource pool that supports techniques for decoding sidelink control information for retransmissions in accordance with one or more aspects of the present disclosure.

FIG. 4 illustrates an example of a wireless communications system that supports techniques for decoding sidelink control information for retransmissions in accordance with one or more aspects of the present disclosure.

FIG. 5 illustrates an example of a process flow in a system that supports techniques for decoding sidelink control information for retransmissions in accordance with one or more aspects of the present disclosure.

FIGS. 6 and 7 show block diagrams of devices that support techniques for decoding sidelink control information for retransmissions in accordance with one or more aspects of the present disclosure.

FIG. 8 shows a block diagram of a communications manager that supports techniques for decoding sidelink control information for retransmissions in accordance with one or more aspects of the present disclosure.

FIG. 9 shows a diagram of a system including a device that supports techniques for decoding sidelink control information for retransmissions in accordance with one or more aspects of the present disclosure.

FIGS. 10 through 15 show flowcharts illustrating methods that support techniques for decoding sidelink control information for retransmissions in accordance with one or more aspects of the present disclosure.

### DETAILED DESCRIPTION

Some wireless communications systems may support high-reliability applications, such as extended reality (XR) applications, in which user equipment (UEs) may communicate with each other via sidelink communications and with a network entity via Uu communications. Such wireless communications systems may support groupcasting configurations, where UEs may broadcast communications (e.g., feedback messages) to other UEs in a group. In some such examples, the UEs may support retransmission (e.g., within the group) of downlink messages received from a network entity based on groupcast feedback, which may enable relatively more efficient use of system resources. For example, a network entity may transmit a downlink message (e.g., physical downlink control channel (PDSCH)) to each UE of a UE group. Some UEs of the group may receive the downlink message, however some other UEs may fail to receive or decode the downlink message and, in response, may groupcast or broadcast feedback (e.g., negative feedback (NACK)) to other UEs of the group indicating the failure. Another UE of the group may receive the feedback and may retransmit, using sidelink resources, the downlink data from the downlink message via a sidelink message (e.g., physical sidelink shared channel (PSSCH)) to the UE(s) that failed to receive or decode the downlink message.

In some sidelink communications, an intended recipient of the sidelink message may perform blind decoding to identity control information (e.g., sidelink control information (SCI) via a physical sidelink control channel (PSCCH)) including information about which resources the sidelink message (e.g., including the data retransmission) is transmitted, among other parameters associated with the PSSCH. Blind decoding, however, may increase processing time and power consumption, which may inhibit XR applications and/or other types of communications which rely on relatively fast and reliable communications.

To decrease reliance on blind decoding, a network entity may transmit a resource configuration to each UE of a group. The resource configuration may assign or map resources over which a transmitting UE may transmit control information (e.g., PSCCH including SCI) for a corresponding data transmission (e.g., a PSSCH). Additionally, or alternatively, the resource configuration may indicate a pattern of resources over which a transmitting UE may transmit the control information according to the pattern based on an availability of each resource in the pattern. Thus, based on the resource configuration, a receiving UE may more efficiently identify resources to monitor for control information thereby decreasing reliance on blind decoding, for example, to receive a downlink data retransmission via sidelink.

In a first aspect, a network entity may split a group of UEs into one or more subgroups and may transmit, to each UE of the group, a resource configuration assigning or configuring a specific subchannel to each UE of a subgroup. The different subchannels may be used by respective UEs to transmit control information associated with a sidelink data transmission (e.g., PSSCH transmission), which may include a retransmission of PDSCH data (e.g., that was not decoded by one or more other UEs). As such, UEs may monitor specific subchannels (e.g., a relatively reduced quantity of subchannels) associated with its subgroup, which may reduce a total quantity of subchannels (e.g., in a resource pool) that may otherwise be monitored for blind decoding.

In a second aspect, a network entity may split a group of UEs into one or more subgroups and may transmit, to each UE of the group, a resource configuration assigning a specific resource to each subgroup of UEs and further assigning a retransmission priority to each UE of the subgroup. The priority may indicate which UE is responsible for retransmissions (e.g., retransmissions of PDSCH) over the assigned group resource when another UE of the group fails to decode a downlink message. As such, the other UE may monitor the subchannel assigned to the subgroup for SCI and the corresponding PSSCH (e.g., including downlink retransmission data), which may decrease blind decoding performed by the UE, as the UE may be aware of which subchannel(s) to monitor for SCI and the corresponding PSSCH transmission.

In a third aspect, a network entity may split a group of UEs into one or more subgroups and may transmit, to each UE of the group, a resource configuration indicating a resource pattern (e.g., order) for decoding control information. For example, the pattern may indicate a first resource (e.g., a first subchannel) to monitor for control information (e.g., SCI), and if the control information is not included in the first resource, the UE may monitor a second resource (e.g., a second subchannel) according to the pattern, and so on. Further, a retransmitting UE may sense resources according to the pattern to find an available subchannel and may select a resource for the retransmission accordingly. As such, a UE may monitor a subset of subchannels of a resource pool based on the resource pattern, enabling the UE to limit an amount of blind decoding performed.

In a fourth aspect, a network entity may split a group of UEs into one or more subgroups and may transmit, to each UE of the group, a resource configuration indicating a mapping between a UE and a set of resources. The network entity may define a lead or primary UE that is responsible for selecting another UE of its subgroup for retransmissions (e.g., retransmissions of downlink data) and may transmit an indication identifying the retransmitting UE to each UE of the subgroup. The selected UE may retransmit data via an assigned resource as indicated by the mapping, and the UE receiving the retransmission may decode the assigned resource based on the indication. As such, the UE may monitor a subchannel associated with the indicated UE, thereby avoiding blind decoding for a relatively larger quantity of resources.

Each example may be implemented individually or in combination with other examples or aspects of other examples. The examples described herein may provide a procedure for more efficient decoding of downlink data retransmissions via sidelink communications. Each example may reduce latency and save power by replacing or reducing instances of control information blind decoding.

Aspects of the disclosure are initially described in the context of wireless communications systems. Aspects of the disclosure are then described in the context of resource configurations and a process flow. Aspects of the disclosure are further illustrated by and described with reference to apparatus diagrams, system diagrams, and flowcharts that relate to techniques for decoding sidelink control information for retransmissions.

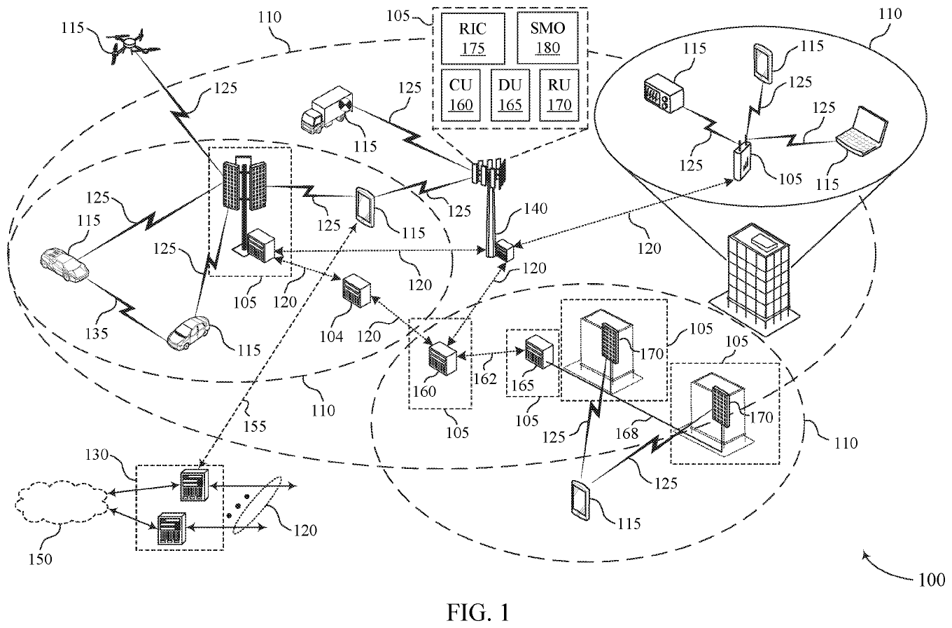

FIG. 1 illustrates an example of a wireless communications system 100 that supports techniques for decoding sidelink control information for retransmissions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for decoding sidelink control information for retransmissions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may, in some examples, support XR applications which rely on low latency, high reliability communications to provide a satisfactory user experience. XR traffic may include instances of XR traffic retransmissions via sidelink communications supporting groupcast which may offload PDSCH retransmission from Uu communication links to sidelink thereby conserving Uu resources, reducing latency caused by Uu congestion, and reducing power consumption. For example, a network entity 105 may transmit a downlink data message to UEs 115 in a group of UEs executing an XR application. One or more of the UEs 115 may groupcast or broadcast feedback indicating whether a downlink data message from the network entity 105 was successfully received (e.g., decoded) to other UEs 115 of the group, rather than to the network entity 105, to offload retransmissions to sidelink. However, in such examples, a UE 115 that is to receive a retransmission via PSSCH may perform blind decoding of control information (e.g., SCI-1) transmitted via PSCCH before decoding PSSCH, as the resources over which the PSCCH are transmitted may not be known to the UE 115 ahead of time. In particular, blind decoding may refer to a UE 115 monitoring some resources via which control information may be transmitted. For the UE 115 to decode the PSCCH (and therefore the SCI), the UE 115 may need to locate which time-frequency resources were used to transmit the PSCCH, which may not be conveyed or known to the UE 115 in advance. As such, the UE 115 may perform decoding on multiple different resources (e.g., within respective search spaces, within a resource pool) until the PSCCH is found (e.g., possibly after being unable to find the PSCCH after multiple attempts). As such, blind decoding PSCCH to receive PSSCH may be time consuming and inefficient because there may be multiple subchannels in an available resource pool to decode, and the UE 115 may consume power when decoding each of the resources in the available resource pool.

For example, each group of UEs 115 may be assigned a resource pool that may include a quantity of resources such as subchannels (e.g., including physical resource blocks). Each subchannel may include SCI (e.g., SCI-1) via PSCCH. A UE 115 may blind decode PSCCH in each subchannel of the resource pool to receive the SCI which may indicate resources over which the TB retransmission is transmitted via PSSCH. In some cases, a UE 115 may be unable to receive PSSCH including TB retransmissions without first blind decoding PSCCH.

To avoid or reduce instances of blind decoding, the wireless communications system 100 may support enhanced SCI (e.g., SCI-1) decoding for XR traffic retransmission via sidelink. The examples described herein may introduce schemes or procedures for UEs 115 (e.g., XR UEs 115) to efficiently decode SCI (e.g., SCI-1) by avoiding instances of blind decoding which may reduce XR traffic retransmission latency, decrease power consumption of XR UEs 115, and may enhance the reliability of XR traffic (e.g., including when Uu retransmissions are offloaded to sidelink).

For example, a UE 115 may receive a configuration for monitoring resources from a resource pool, where the resources may be associated with a respective group of UEs 115. In some examples, the configuration may indicate a pattern of resources, the pattern indicating an ordering of subchannels for retransmissions of downlink data. The UE 115 may broadcast a feedback message based on failing to decode downlink data transmitted by a network entity 105 and may monitor a first subset of resources for SCI via PSCCH based on the configuration or the pattern and based on broadcasting the feedback message. The UE 115 may receive, from a second UE 115 and via the first subset of resources, a sidelink message comprising the SCI based on the monitoring, where the SCI may indicate a sidelink data channel for receiving a retransmission of the downlink data.

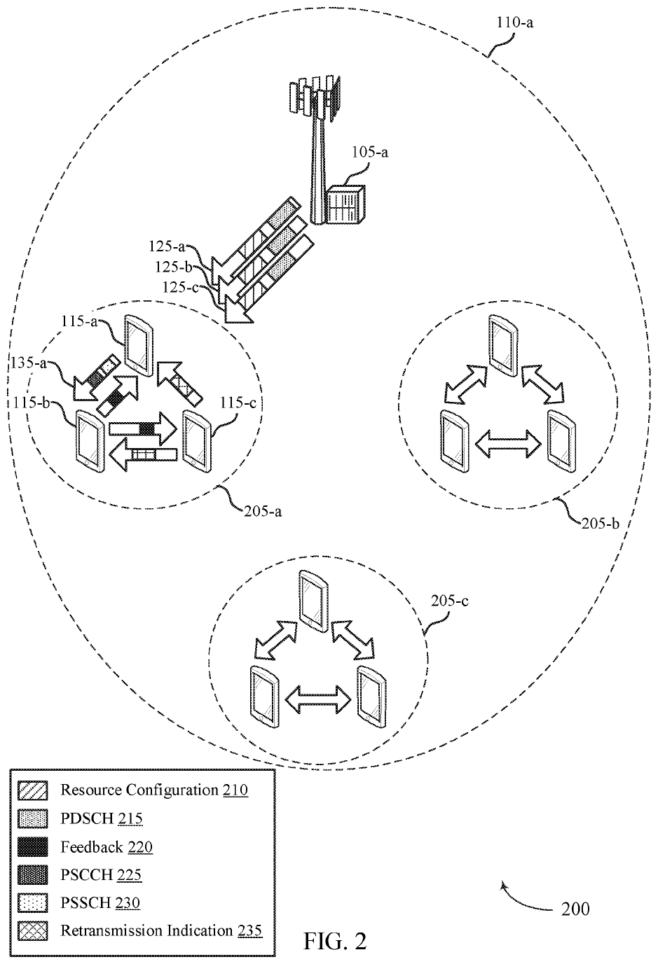

FIG. 2 illustrates an example of a wireless communications system 200 that supports techniques for decoding sidelink control information for retransmissions in accordance with one or more aspects of the present disclosure. The wireless communications system 200 may include UE 115-a, UE 115-b, and UE 115-c, as well as other UEs 115, which may each be an example of the corresponding UEs 115 described with reference to FIG. 1. Likewise, the wireless communications system 200 may include a network entity 105-a, which may be an example of corresponding network entities 105 described with reference to FIG. 1. The wireless communications system 200 may include a first UE subgroup 205-a including UE 115-a, UE 115-b, and UE 115-c, a second UE subgroup 205-b including one or more UEs 115, and a third UE subgroup 205-c including one or more UEs 115. The network entity 105-a may serve each of the UEs 115 in the coverage area 110-a.

The wireless communications system 200 may support XR applications in which the UEs 115 may communicate with each other via sidelinks 135 and with the network entity 105-a via communication links 125. For example, the wireless communications system 200 may support groupcasting configurations where the UEs 115 may broadcast communications, such as feedback, to other UEs 115 in a group. In such examples, some UEs 115 may support retransmission (e.g., within the group) of downlink data received from the network entity 105-a, which may enable more efficient use of system resources. For example, UEs 115-a and 115-c may receive PDSCH 215 via communication links 125-a and 125-c, respectively, from the network entity 105-b and may retransmit a TB received via the PDSCH 215 to one or more other UEs (e.g., UE 115-b) that failed to receive or decode the TB transmitted via PDSCH 215 over communication link 125-b using sidelink 135-a. The UE 115-a may retransmit the TB via PSSCH 230 and may transmit an associated PSCCH 225 carrying SCI. However, in some sidelink communications, the UE 115-b receiving the PSSCH 230 and the associated PSCCH 225 carrying SCI may perform blind decoding to identify SCI in the PSCCH 225 before decoding the TB retransmission transmitted via PSSCH 230. In such cases, subchannels used for sidelink transmissions may be associated with a resource pool (e.g., a resource pool configured by the network entity 105-a), and the UE 115-b may perform blind decoding for each resource of the resource pool until SCI is decoded. Blind decoding may consume excessive processing time and energy which may be detrimental to XR applications which rely on relatively fast and reliable communications (e.g., to provide a satisfactory user experience). Thus, the wireless communications system may support procedures for avoiding blind decoding instances and mitigating negative effects caused by blind decoding.

In a first example, the network entity 105-b may divide or assign the plurality of UEs 115 into one or more subgroups 205 and may transmit a resource configuration 210, for example, to each of UEs 115-a, 115-b, and 115-c in the subgroup 205-a that assigns or configures a specific subchannel to each UE 115 of the subgroup 205-a for transmitting PSCCH 225 including SCI that is associated with a PSSCH 230 including a PDSCH TB retransmission. The network entity 105-a may transmit resource configuration 210 to each of UEs 115-a, 115-b, and 115-c via communication links 125-a, 125-b, and 125-c respectively, where the resource configuration 210 assigns a subchannel from the resource pool to each UE 115 of the subgroup 205-a. The network entity 105-a may configure each subgroup 205 to include UEs 115 having a similar downlink beam direction. For example, UEs 115, having a downlink beam direction within a threshold beam direction with respect to other downlink communication beam directions of other UEs 115, may be assigned to a same subgroup 205. One or more other parameters may be used when including various UEs 115 into the subgroups 205.

The network entity 105-a may transmit PDSCH 215 to each of UEs 115-a, 115-b, and 115-c via communication links 125-a, 125-b, and 125-c respectively. UEs 115-a and 115-c may successfully decode and receive the data (e.g., one or more TBs) carried by the PDSCH 215, whereas UE 115-b may fail to receive and/or decode the data (e.g., TB) carried by PDSCH 215. In response, the UE 115-b may groupcast or broadcast feedback 220 to each of UEs 115-a and UE 115-c in the first UE subgroup 205-a and may monitor the subchannels associated with UEs 115-a and 115-c as indicated by the resource configuration 210 for SCI carried by PSCCH 225 and the associated TB transmission carried by PSSCH 230.

In a second example, the network entity 105-b may divide or assign the plurality of UEs 115 into subgroups 205 and may transmit a resource configuration 210 to each of UEs 115-a, 115-b, and 115-c in the subgroup 205-a that assigns or configures a specific resource (e.g., subchannel) to each subgroup 205 for transmitting PSCCH 225 including SCI associated with a PSSCH 230 including a PDSCH TB retransmission and that assigns each UE 115 of a subgroup 205 a retransmission priority that dictates which UE 115 is responsible for retransmission over the assigned group subchannel. For example, the network entity 105-a may transmit resource configuration 210 to each of UEs 115-a, 115-b, and 115-c via communication links 125-a, 125-b, and 125-c respectively where the resource configuration 210 assigns a subchannel from the resource pool to the subgroup 205-a.

The network entity 105-a may transmit PDSCH 215 to each of UEs 115-a, 115-b, and 115-c via communication links 125-a, 125-b, and 125-c respectively. However, UEs 115-a and 115-c may successfully receive and decode the data (e.g., TBs) carried by the PDSCH and UE 115-b may fail to receive and/or decode the data (e.g., TBs) carried by PDSCH 215. The UE 115-b may groupcast or broadcast feedback 220 to each of UEs 115-a and UE 115-c in the first UE subgroup 205-a. The UE 115-a may have a higher priority than the UE 115-c and may thus perform the TB retransmission via the subchannel associated with the first UE subgroup 205-a. The UE 115-b may monitor the subchannel associated with the first UE subgroup 205-a as indicated by the resource configuration 210 for SCI carried by PSCCH 225 and the associated TB transmission carried by PSSCH 230.

In a third example, the network entity 105-b may divide or assign the plurality of UEs 115 into subgroups 205 and may transmit a resource configuration 210 to each of UEs 115-a, 115-b, and 115-c in the subgroup 205-a that defines a resource pattern for transmitting and decoding PSCCH 225 carrying SCI associated with a PSSCH 230 that includes a PDSCH TB retransmission. For example, the network entity 105-a may transmit resource configuration 210 to each of UEs 115-a, 115-b, and 115-c via communication links 125-a, 125-b, and 125-c, respectively, where the resource configuration 210 indicates a pattern of resources that includes an order of subchannels from the resource pool for transmitting SCI associated with a TB retransmission.

The network entity 105-a may transmit PDSCH 215 to each of UEs 115-a, 115-b, and 115-c via communication links 125-a, 125-b, and 125-c, respectively. UEs 115-a and 115-c may successfully receive and decode the data (e.g., TB) carried by the PDSCH, but UE 115-b may fail to receive and/or decode the data (e.g., TB) carried by PDSCH 215. The UE 115-b may broadcast or groupcast feedback 220 to each of UEs 115-a and UE 115-c in the first UE subgroup 205-a. Each subchannel of the resource pool may be assigned or configured with a maximum priority (e.g., threshold priority) and any UE 115 that is associated with a communication priority that is higher than the maximum priority (e.g., threshold priority) of a subchannel may reserve a subchannel for sidelink transmissions other than TB retransmissions. For example, the UE 115-a may receive the feedback 220 and may sense each subchannel according to the pattern and may detect that one or more subchannels are dedicated to other sidelink communications until an available subchannel is identified. The UE 115-a may attempt to transmit the SCI until it finds an unoccupied subchannel. The UE 115-b may monitor the subchannels according to the pattern. For example, the UE 115-b may identify the specific subchannels that likely contain the TB based on the indicated pattern and may attempt to decode SCI (e.g., SCI-1) according to the pattern until the SCI is decoded.

In a fourth example, the network entity 105-b may divide or assign the plurality of UEs 115 into subgroups 205 and may transmit a resource configuration 210 to each of UEs 115-a, 115-b, and 115-c in the subgroup 205-a that assigns or configures a specific subchannel to each UE 115 of the subgroup 205-a for transmitting PSCCH 225 including SCI associated with a PSSCH 230 that includes a PDSCH TB retransmission and may additionally indicate a primary or lead UE 115-c that selects another UE 115 (e.g., UE 115-a) for TB retransmission. For example, the network entity 105-a may transmit resource configuration 210 to each of UEs 115-a, 115-b, and 115-c via communication links 125-a, 125-b, and 125-c, respectively, where the resource configuration 210 assigns a subchannel from the resource pool to each UE 115 of the subgroup 205-a and additionally indicates the UE 115-c as the primary UE of subgroup 205-a.

The network entity 105-a may transmit PDSCH 215 to each of UEs 115-a, 115-b, and 115-c via communication links 125-a, 125-b, and 125-c respectively. However, UEs 115-a and 115-c may successfully receive and decode the data (e.g., TB) carried by the PDSCH 215 and the UE 115-b may fail to receive and/or decode the data (e.g., TB) carried by PDSCH 215. The UE 115-b may broadcast or groupcast feedback 220 to each of UEs 115-a and UE 115-c in the first UE subgroup 205-a and the UE 115-c may transmit a retransmission indication 235 of the retransmitting UE 115-a to each UE 115 of the subgroup 205-a. The UE 115-b may receive the indication and may monitor the subchannel associated with UE 115-a as indicated by the resource configuration 210 and the retransmission indication 235 for SCI carried by PSCCH 225 and the associated TB retransmission carried by PSSCH 230.

Each example described herein provides a procedure for relatively more efficient decoding of downlink control information associated with downlink data that is retransmitted by another UE 115 via sidelink 135. For example, the described solutions may reduce latency and save power by replacing or reducing instances of blind decoding.

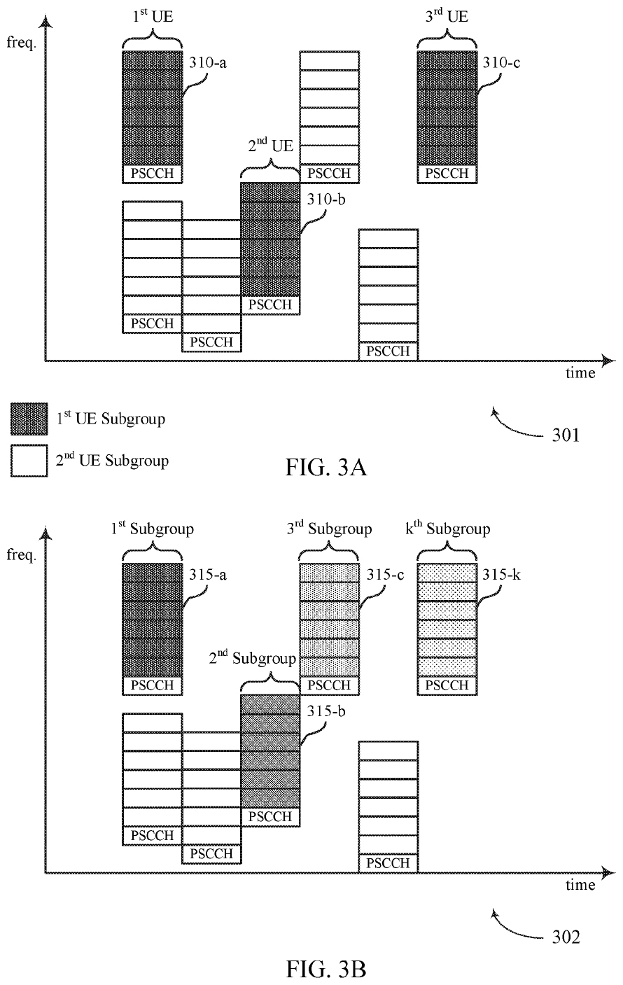

FIGS. 3A and 3B illustrate examples of a resource pool 301 and 302, respectively, that support techniques for decoding sidelink control information for retransmissions in accordance with one or more aspects of the present disclosure. The resource pool 301 may include subchannels 310, each associated with a UE and each including a PSSCH carrying SCI. The resource pool 302 may include subchannels 315, each associated with a subgroup and each including a PSSCH carrying SCI.

In the example of resource pool 301, a group of UEs (e.g., UEs 115 as described with reference to FIGS. 1 and 2) that are served by a network entity (e.g., a network entity 105 as described with reference to FIGS. 1 and 2) may be split or assigned into subgroups via a resource configuration transmitted by the network entity or via a static configuration (e.g., pre-configuration). The network entity may configure each subgroup to include UEs having a similar downlink beam direction. For example, UEs having a downlink beam direction within a threshold beam direction with respect to other downlink communication beam directions of other UEs may be assigned to a same subgroup. For example, the network entity may transmit the resource configuration indicating a set of UEs composing a first UE subgroup and a set of UEs composing a second UE subgroup as well as a resources associated with each UE of the subgroup. The resource configuration may indicate or assign a subchannel 310 from the resource pool 301 to each UE of a subgroup for retransmission of downlink data. For example, the resource configuration may indicate that subchannel 310-a is assigned to a first UE of the first UE subgroup, subchannel 310-b is assigned to a second UE of the first UE subgroup, and subchannel 310-c is assigned to a third UE of the first UE subgroup.

When a UE fails to decode a PDSCH TB transmitted by the network entity, the UE may groupcast feedback (e.g., NACK) via PSFCH to other UEs of the subgroup. Other UEs of the subgroup may receive the feedback and may transmit PSCCH and PSSCH including the PDSCH TB via the assigned resources. The UE that failed to decode the PDSCH may decode the subchannels assigned to the other UEs based on the resource configuration, thereby avoiding a blind decoding of each resource in the resource pool 301.

In the example of resource pool 302, a group of UEs (e.g., UEs 115 as described with reference to FIGS. 1 and 2) that are served by a network entity (e.g., a network entity 105 as described with reference to FIGS. 1 and 2) may be split or assigned into subgroups via a resource configuration transmitted by the network entity or via a static configuration (e.g., pre-configuration). For example, the network entity may transmit the resource configuration indicating a set of UEs composing a first UE subgroup, a set of UEs composing a second UE subgroup, and so on until a k^{th} subgroup, as well as sets of resources associated with each subgroup. The resource configuration may indicate or assign a subchannel 315 from the resource pool 302 to each UE subgroup for retransmission of downlink data. For example, the resource configuration may indicate that subchannel 315-a is assigned to a first UE subgroup, subchannel 315-b is assigned to a second UE subgroup, subchannel 315-c is assigned to a third UE subgroup, and subchannel 315-k is assigned to a k^{th} UE subgroup.

The resource configuration may further indicate that a first UE of a first subgroup has a priority that is higher than a second UE of the first subgroup, and the second UE has a priority higher than a third UE of the first subgroup. If the third UE fails to decode a TB transmitted via PDSCH, the third UE may broadcast or groupcast a NACK to each UE of the first subgroup and the UE having the relatively highest priority and that successfully decoded the PDSCH may be responsible for retransmitting the TB. For example, if the first UE successfully decodes the PDSCH, then the first UE may be responsible for retransmitting the TB via the subchannel 315-a associated with the first subgroup. However, if the third UE and the first UE fails to decode the PDSCH, then the second UE may be responsible for retransmitting the TB via the subchannel 315-a associated with the first subgroup because it is associated with the next-highest priority and has successfully decoded the TB. One UE per subgroup may perform a retransmission via the assigned subchannel 315 during a slot. In such cases, the transmission of SCI via the assigned subchannel may preclude other UEs of the subgroup from transmitting during a same time period. The UEs in the subgroup may identify the configured sidelink subgroup resource based on the resource configuration and may monitor the assigned resource for control information associated with the retransmission such that blind decoding may be avoided. In some examples, all UEs of a subgroup may fail to decode the TB transmitted via PDSCH and the network entity may be responsible for retransmitting the TB via Uu according to Uu HARQ procedures.

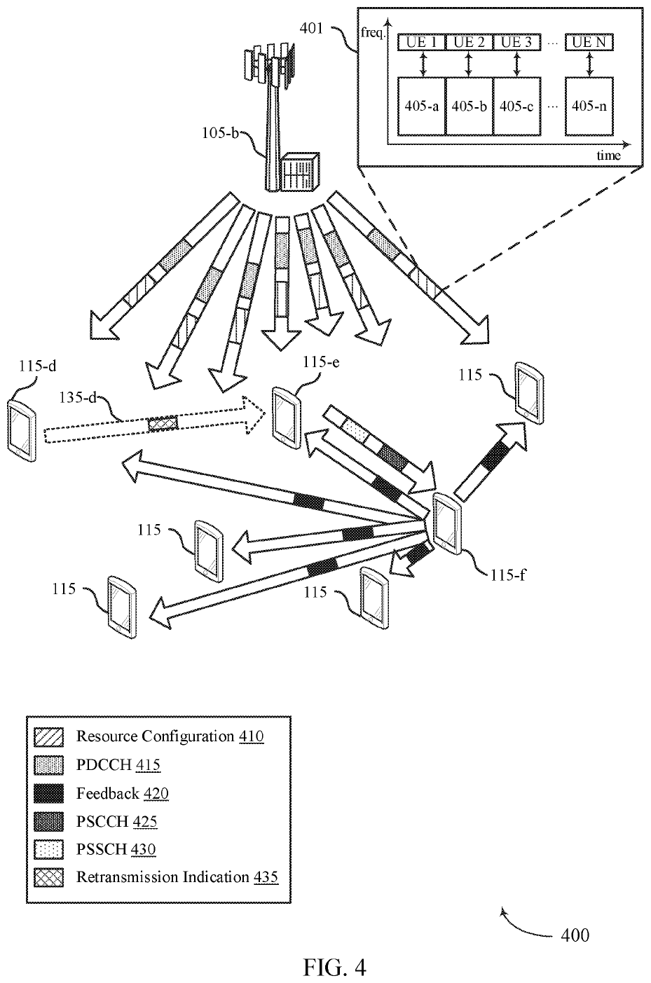

FIG. 4 illustrates an example of a wireless communications system 400 that supports techniques for decoding sidelink control information for retransmissions in accordance with one or more aspects of the present disclosure. The wireless communications system 400 may include UE 115-d, UE 115-e, and UE 115-f as well as other UEs 115 which may each be an example of the corresponding UEs 115 described with reference to FIGS. 1 and 2. Likewise the wireless communications system 400 may include a network entity 105-b, which may be an example of corresponding network entities 105 described with reference to FIGS. 1 and 2. The UEs 115 of the wireless communications system 400 may constitute a UE subgroup as described herein and the network entity 105-b may serve each of the UEs 115 in the UE subgroup. The wireless communications system 400 may, in some examples, additionally include a mapping 401.

In some examples of the wireless communications system 400, the network entity 105-b may transmit a resource configuration 410 to each UE 115 in the UE subgroup for pattern-based resource reservation for retransmissions of XR traffic (e.g., PDSCH 415) via sidelink 135. For example, the network entity 105-b may configure a pattern or an order of resources from a resource pool for TB retransmission via sidelink 135. The resources may be subchannels and may be indicated as Sₙ, Sₙ₊₁, Sₙ₊₂, . . . , Sₙ₊ₓ. Each UE 115 of the UE subgroup may receive the resource configuration 410 including the indication of the pattern and thus may identify resources for TB retransmission and reception. Each subchannel of the resource pool may be assigned or configured with a threshold priority (e.g., a maximum priority) and any UE 115 that is associated with a communication priority that is higher than the threshold priority (e.g., maximum priority) of a channel may reserve a subchannel S_{q} for sidelink transmissions other than TB retransmissions.

For example, the UE 115-f may fail to decode PDSCH 415 from the network entity 105-b and the UE 115-f may broadcast or groupcast negative feedback 420 to other UEs 115 of the UE subgroup. The UE 115-e may receive the NACK and may sense each subchannel according to the pattern, starting with Sₙ until an available subchannel is identified. For example, if Sₙ is reserved by a UE 115 having a priority that satisfies the threshold priority (e.g., maximum priority) of subchannel, Sₙ, then the subchannel, Sₙ may be unavailable for retransmissions and the UE 115-e may sense Sₙ₊₁ (e.g., using a channel access procedure, such as a listen-before-talk (LBT) procedure), and so on, until a suitable subchannel is identified as available for transmission. For example, the UE 115-e may transmit PSCCH 425 including SCI and may retransmit the TB via PSSCH 430 until an unoccupied subchannel is identified. Based on transmitting the negative feedback 420, the UE 115-f may monitor one or more subchannels according to the pattern. For example, the UE 115-f may know the specific subchannels that likely contain the TB based on the indicated pattern and may attempt to decode SCI (e.g., SCI-1) from Sₙ to Sₙ+x until SCI is decoded. Each subchannel may be reused by other UEs 115 after the retransmission.

In some other examples, the network entity 105-b may transmit a resource configuration 410 that assigns or specifies a resource (e.g., subchannel) for each XR UE 115 to use for retransmissions that may be scheduled by a primary or a lead UE 115. For example, the network entity 105-b may configure a mapping 401 between UEs 115 and subchannels 405-a, 405-b, 405-c, . . . , 405-n which may be preconfigured or semi-statically configured and may transmit the resource configuration 410 including the mapping 401 to each UE 115 of the subgroup. Additionally, the resource configuration 410 may identify a primary UE 115-d that is responsible for selecting a UE 115 of the UE subgroup to perform the TB retransmission. For example, a third UE 115-f may fail to decode the PDSCH 415 from the network entity 105-b and may broadcast or groupcast negative feedback 420 (e.g., NACK).

Based on receiving the NACK, the primary UE 115-d may indicate a second UE 115-e (e.g., that successfully decoded the PDSCH) to retransmit the TB on the associated subchannel 405-b according to the mapping. For example, the primary UE 115-d may transmit, via the subchannel 405-a mapped to the primary UE 115-d, a retransmission indication 435 of the UE 115-e that is selected for TB retransmission to each UE 115 (e.g., including UE 115-e via sidelink 135-d) of the subgroup such that the third UE 115-f that failed to decode the PDSCH 415 may expect a retransmission via the subchannel 405-b associated with the selected second UE 115-e. In some examples, the second UE 115-e may be selected randomly or may be selected based on one or more channel quality parameters (e.g., SINR). The third UE 115-f may receive (e.g., decode) the retransmission indication 435 via the subchannel 405-a mapped to the primary UE 115-d and may monitor the subchannel 405-b mapped to the second UE 115-e for SCI associated with the TB retransmission. The third UE 115-f may decode the SCI (e.g., SCI-1) on the subchannel 405-b mapped to the second UE 115-e thereby avoiding blind decoding instances.

In some instances, the primary UE 115-d may select UE 115-f for TB retransmission to another UE 115 of the UE group and the UE 115-f may transmit SCI associated with the TB retransmission vias the subchannel 405-c mapped to the third UE 115-f.

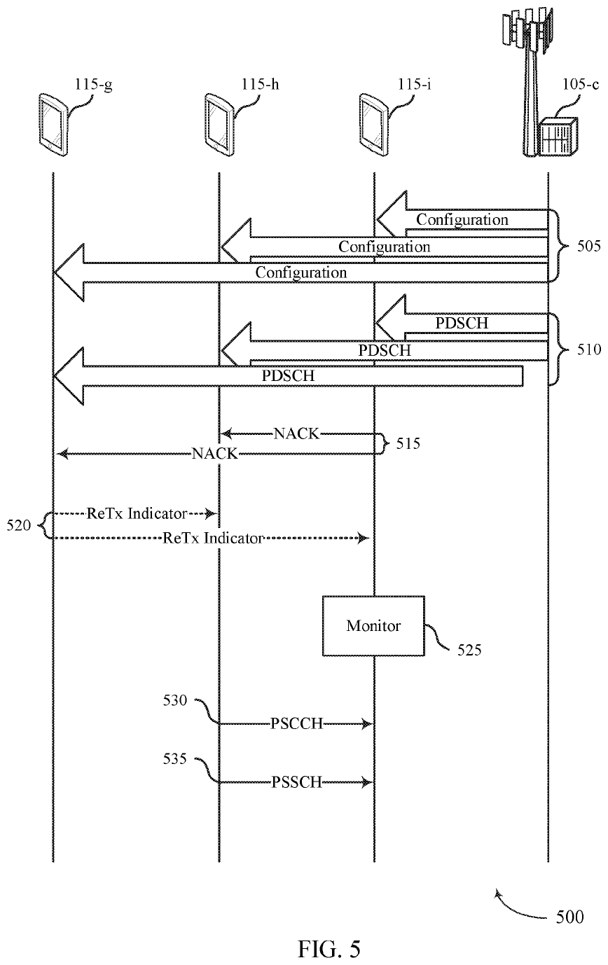

FIG. 5 illustrates an example of a process flow 500 in a system that supports techniques for decoding sidelink control information for retransmissions in accordance with one or more aspects of the present disclosure. For example, the process flow 500 may include a network entity 105-c, which may be an example of corresponding network entities 105 described with reference to FIGS. 1, 2, and 4. Likewise, the process flow 500 may include a UE 115-g, a UE 115-h, and a UE 115-i which may be examples of corresponding UEs 115 described with reference to FIGS. 1, 2, and 4. In the following description of the process flow 500, the operations between the UE 115-g, UE 115-h, UE 115-i, and network entity 105-c may be performed in a different order than the example order shown, or the operations performed by the UE 115-g, UE 115-h, UE 115-i, and network entity 105-c may be performed in different orders or at different times or by different devices. Some operations may also be omitted from the process flow 500, and other operations may be added to the process flow 500. The operations performed by the UE 115-g, UE 115-h, ULE 115-i, and network entity 105-c may support improvements to sidelink control information decoding and, in some examples, may promote improvements to communications efficiency, latency, and power consumption, among other benefits.

At 505, the UE 115-g, UE 115-h, and UE 115-i may receive, from the network entity 105-c, a message indicating a configuration for monitoring one or more subsets of resources from a resource pool. The UE 115-g, UE 115-h, and UE 115-i may compose a first UE group of one or more UE groups and the one or more subsets of resources may be associated with the first UE group. The network entity 105-c may configure the UE group to include UEs 115-g, 115-h, and 115-i based on the UEs 115 having a similar downlink beam direction. For example, UEs 115-g, 115-h, and 115-i may have a downlink beam direction that is within a threshold beam direction with respect to each other and may therefore be assigned to a same subgroup. In some examples, the resource pool may include a plurality of subchannels and each of UE 115-g, UE 115-h, and UE 115-i may be associated with a respective subchannel of the plurality. The configuration, in some instances, may further indicate a mapping between each of UE 115-g, UE 115-h, and UE 115-i and a respective resource (e.g., subchannel) of the resource pool. The configuration, in some instances, may further indicate a relative priority of each of UE 115-g, UE 115-h, and UE 115-i. Additionally, or alternatively, the configuration may indicate a pattern of resources, the pattern of resources including an ordering of respective subchannels of a plurality of subchannels of a resource pool for retransmissions of downlink data via a sidelink data channel.

At 510, the network entity 105-c may transmit downlink data to each of UE 115-g, UE 115-h, and UE 115-i. The UE 115-g and the UE 115-h may receive the PDSCH and successfully decode a TB transmitted via the PDSCH. The UE 115-i however, may fail to decode the TB transmitted via the PDSCH and at 515, may broadcast or groupcast a NACK indicating the UE 115-i failed to decode the TB.

In some examples, the configuration transmitted at 505 may indicate that UE 115-g is a primary UE (e.g., a head UE, a lead UE, or other like terminology) and at 520, the UE 115-g may transmit an indicator to each of UE 115-h and UE 115-i indicating that UE 115-h will retransmit the TB via PSSCH. Additionally, or alternatively, the UE 115-h may be associated with a higher priority than the UE 115-g and may be responsible for the TB retransmission based on being associated with the higher priority.

At 525, the UE 115-i may monitor a first subset of resources of the one or more subsets of resources for SCI based on the configuration and broadcasting the NACK. In some examples, the UE 115-i may monitor a first subchannel associated with the UE 115-h or associated with the first subgroup for the SCI or may monitor a set of subchannels according to the pattern received via the configuration. For example, the UE 115-i may monitor a first subchannel indicated by the pattern and if it does not receive the SCI (e.g., there is an absence of SCI in the first subchannel), may monitor a second subchannel indicated by the pattern until the UE 115-i detects and, at 530, receives the PSCCH and decodes the associated SCI.

At 535, the UE 115-i may receive PSSCH including the TB retransmission from the UE 115-h based on receiving the PSCCH at 530 and decoding the SCI.

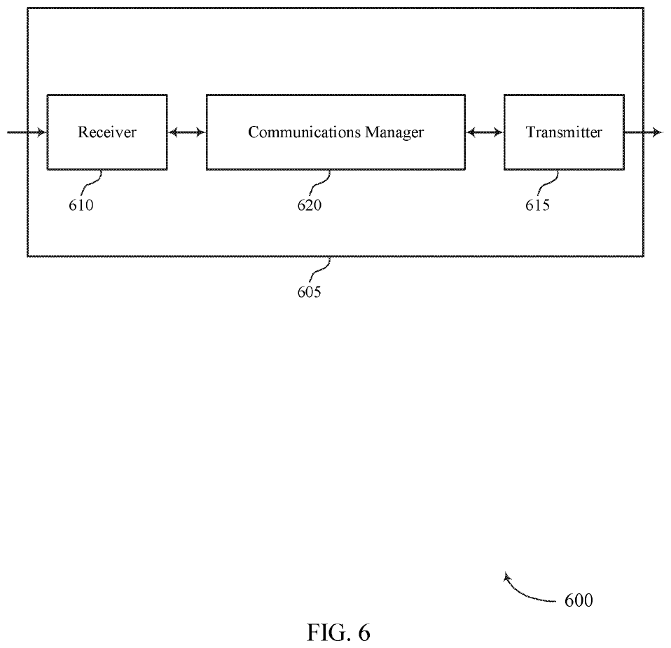

FIG. 6 shows a block diagram 600 of a device 605 that supports techniques for decoding sidelink control information for retransmissions in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for decoding sidelink control information for retransmissions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for decoding sidelink control information for retransmissions). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for decoding sidelink control information for retransmissions as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first UE in accordance with examples as disclosed herein. For example, the communications manager 620 may be configured as or otherwise support a means for receiving a message indicating a configuration for monitoring one or more subsets of resources from a resource pool, the one or more subsets of resources being associated with a respective UE group of one or more UE groups. The communications manager 620 may be configured as or otherwise support a means for broadcasting, to two or more UEs, a feedback message based at least in part on failing to decode a downlink transmission including downlink data. The communications manager 620 may be configured as or otherwise support a means for monitoring a first subset of resources of the one or more subsets of resources for sidelink control information based on the configuration and broadcasting the feedback message. The communications manager 620 may be configured as or otherwise support a means for receiving, from a second UE and via the first subset of resources, a sidelink message including the sidelink control information based on the monitoring, the sidelink control information indicating a sidelink data channel for a retransmission of the downlink data based on the feedback message, the first subset of resources corresponding to a first UE group that includes the second UE.

Additionally, or alternatively, the communications manager 620 may support wireless communication at a first UE in accordance with examples as disclosed herein. For example, the communications manager 620 may be configured as or otherwise support a means for receiving a message indicating a configuration for monitoring one or more resources in accordance with a pattern of resources, the pattern of resources indicating an ordering of respective subchannels of a set of multiple subchannels for retransmissions of downlink data via a sidelink data channel. The communications manager 620 may be configured as or otherwise support a means for broadcasting, to one or more UEs, a feedback message based at least in part on failing to decode a downlink transmission including the downlink data. The communications manager 620 may be configured as or otherwise support a means for monitoring, in accordance with the ordering, one or more subchannels of the set of multiple subchannels for sidelink control information based on the configuration and broadcasting the feedback message. The communications manager 620 may be configured as or otherwise support a means for receiving, from a second UE, a sidelink message including the sidelink control information based on the monitoring, the sidelink control information indicating a sidelink data channel for a retransmission of the downlink data based on the feedback message.

Additionally, or alternatively, the communications manager 620 may support wireless communications at a first UE in accordance with examples as disclosed herein. For example, the communications manager 620 may be configured as or otherwise support a means for receiving a message indicating a configuration for transmissions using one or more subsets of resources from a resource pool, the one or more subsets of resources being associated with a respective UE group of one or more UE groups, where each UE group of the one or more UE groups includes at least one UE. The communications manager 620 may be configured as or otherwise support a means for receiving, from a second UE, a feedback message indicating the second UE failed to decode a downlink transmission including downlink data. The communications manager 620 may be configured as or otherwise support a means for transmitting, to the second UE via a first subset of resources, a sidelink message including sidelink control information based on the configuration and receiving the feedback message, the sidelink control information indicating a sidelink data channel for a retransmission of the downlink data, the first subset of resources corresponding to a first UE group that includes the second UE.

Additionally, or alternatively, the communications manager 620 may support wireless communication at a first UE in accordance with examples as disclosed herein. For example, the communications manager 620 may be configured as or otherwise support a means for receiving a message indicating a configuration for sidelink transmissions in accordance with a pattern of resources, the pattern of resources indicating an ordering of respective subchannels of a set of multiple subchannels for retransmissions of downlink data via a sidelink data channel. The communications manager 620 may be configured as or otherwise support a means for receiving, from a second UE, a feedback message indicating the second UE failed to decode a downlink transmission including the downlink data. The communications manager 620 may be configured as or otherwise support a means for transmitting, in response to receiving the feedback message and in accordance with the ordering, sidelink control information via one or more subchannels of the set of multiple subchannels based on receiving the feedback message and the configuration, the sidelink control information indicating a sidelink data channel for a retransmission of the downlink data. The communications manager 620 may be configured as or otherwise support a means for transmitting, to the second UE, the sidelink data channel including the retransmission of the downlink data based on transmitting the sidelink control information.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced latency, reduced power consumption, increased reliability, and more efficient utilization of communication resources, among other examples.

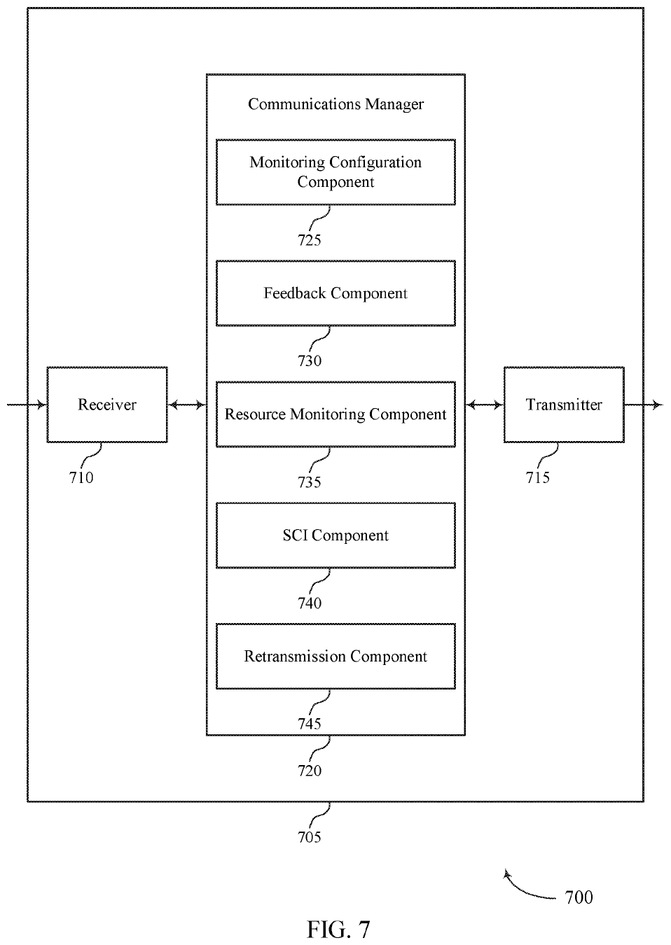

FIG. 7 shows a block diagram 700 of a device 705 that supports techniques for decoding sidelink control information for retransmissions in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for decoding sidelink control information for retransmissions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for decoding sidelink control information for retransmissions). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for decoding sidelink control information for retransmissions as described herein. For example, the communications manager 720 may include a monitoring configuration component 725, a feedback component 730, a resource monitoring component 735, an SCI component 740, a retransmission component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a first UE in accordance with examples as disclosed herein. The monitoring configuration component 725 may be configured as or otherwise support a means for receiving a message indicating a configuration for monitoring one or more subsets of resources from a resource pool, the one or more subsets of resources being associated with a respective UE group of one or more UE groups. The feedback component 730 may be configured as or otherwise support a means for broadcasting, to two or more UEs, a feedback message based on failing to decode a downlink transmission including downlink data. The resource monitoring component 735 may be configured as or otherwise support a means for monitoring a first subset of resources of the one or more subsets of resources for sidelink control information based on the configuration and broadcasting the feedback message. The SCI component 740 may be configured as or otherwise support a means for receiving, from a second UE and via the first subset of resources, a sidelink message including the sidelink control information based on the monitoring, the sidelink control information indicating a sidelink data channel for a retransmission of the downlink data based on the feedback message, the first subset of resources corresponding to a first UE group that includes the second UE.

Additionally, or alternatively, the communications manager 720 may support wireless communication at a first UE in accordance with examples as disclosed herein. The monitoring configuration component 725 may be configured as or otherwise support a means for receiving a message indicating a configuration for monitoring one or more resources in accordance with a pattern of resources, the pattern of resources indicating an ordering of respective subchannels of a set of multiple subchannels for retransmissions of downlink data via a sidelink data channel. The feedback component 730 may be configured as or otherwise support a means for broadcasting, to one or more UEs, a feedback message based on failing to decode a downlink transmission including the downlink data. The resource monitoring component 735 may be configured as or otherwise support a means for monitoring, in accordance with the ordering, one or more subchannels of the set of multiple subchannels for sidelink control information based on the configuration and broadcasting the feedback message. The SCI component 740 may be configured as or otherwise support a means for receiving, from a second UE, a sidelink message including the sidelink control information based on the monitoring, the sidelink control information indicating a sidelink data channel for a retransmission of the downlink data based on the feedback message.

Additionally, or alternatively, the communications manager 720 may support wireless communications at a first UE in accordance with examples as disclosed herein. The monitoring configuration component 725 may be configured as or otherwise support a means for receiving a message indicating a configuration for transmissions using one or more subsets of resources from a resource pool, the one or more subsets of resources being associated with a respective UE group of one or more UE groups, where each UE group of the one or more UE groups includes at least one UE. The feedback component 730 may be configured as or otherwise support a means for receiving, from a second UE, a feedback message indicating the second UE failed to decode a downlink transmission including downlink data. The SCI component 740 may be configured as or otherwise support a means for transmitting, to the second UE via a first subset of resources, a sidelink message including sidelink control information based on the configuration and receiving the feedback message, the sidelink control information indicating a sidelink data channel for a retransmission of the downlink data, the first subset of resources corresponding to a first UE group that includes the second UE.

Additionally, or alternatively, the communications manager 720 may support wireless communication at a first UE in accordance with examples as disclosed herein. The monitoring configuration component 725 may be configured as or otherwise support a means for receiving a message indicating a configuration for sidelink transmissions in accordance with a pattern of resources, the pattern of resources indicating an ordering of respective subchannels of a set of multiple subchannels for retransmissions of downlink data via a sidelink data channel. The feedback component 730 may be configured as or otherwise support a means for receiving, from a second UE, a feedback message indicating the second UE failed to decode a downlink transmission including the downlink data. The SCI component 740 may be configured as or otherwise support a means for transmitting, in response to receiving the feedback message and in accordance with the ordering, sidelink control information via one or more subchannels of the set of multiple subchannels based on receiving the feedback message and the configuration, the sidelink control information indicating a sidelink data channel for a retransmission of the downlink data. The retransmission component 745 may be configured as or otherwise support a means for transmitting, to the second UE, the sidelink data channel including the retransmission of the downlink data based on transmitting the sidelink control information.

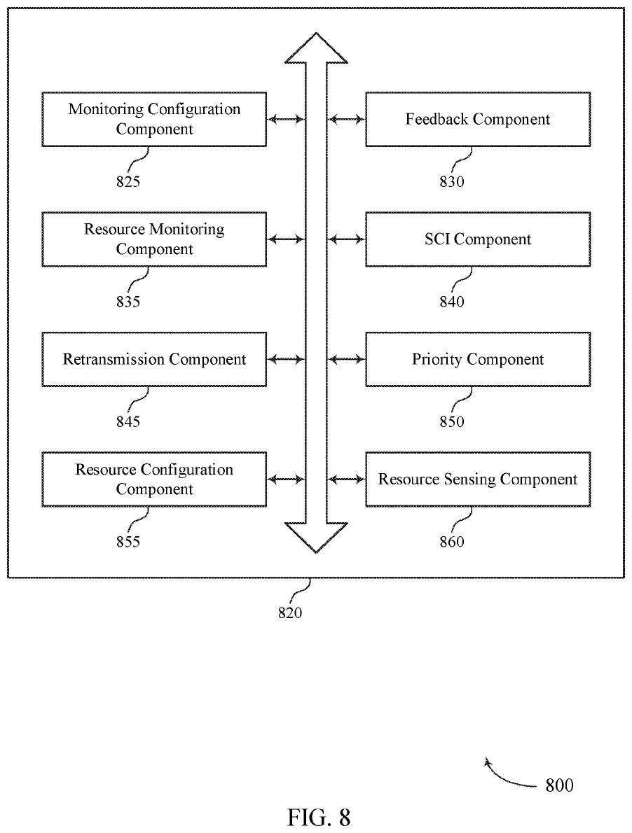

FIG. 8 shows a block diagram 800 of a communications manager 820 that supports techniques for decoding sidelink control information for retransmissions in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for decoding sidelink control information for retransmissions as described herein. For example, the communications manager 820 may include a monitoring configuration component 825, a feedback component 830, a resource monitoring component 835, an SCI component 840, a retransmission component 845, a priority component 850, a resource configuration component 855, a resource sensing component 860, or any combination thereof. Each of these components may communicate, directly or indirectly, with one another (e.g., via one or more buses).

The communications manager 820 may support wireless communications at a first UE in accordance with examples as disclosed herein. The monitoring configuration component 825 may be configured as or otherwise support a means for receiving a message indicating a configuration for monitoring one or more subsets of resources from a resource pool, the one or more subsets of resources being associated with a respective UE group of one or more UE groups. The feedback component 830 may be configured as or otherwise support a means for broadcasting, to two or more UEs, a feedback message based on failing to decode a downlink transmission including downlink data. The resource monitoring component 835 may be configured as or otherwise support a means for monitoring a first subset of resources of the one or more subsets of resources for sidelink control information based on the configuration and broadcasting the feedback message. The SCI component 840 may be configured as or otherwise support a means for receiving, from a second UE and via the first subset of resources, a sidelink message including the sidelink control information based on the monitoring, the sidelink control information indicating a sidelink data channel for a retransmission of the downlink data based on the feedback message, the first subset of resources corresponding to a first UE group that includes the second UE.

In some examples, to support monitoring the first subset of resources, the resource monitoring component 835 may be configured as or otherwise support a means for monitoring a first subchannel associated with the second UE for the sidelink control information.

In some examples, the configuration further indicates a mapping between each UE of the first UE group and the respective subchannel of the set of multiple subchannels. In some examples, receiving the sidelink message is based on the mapping.

In some examples, the retransmission component 845 may be configured as or otherwise support a means for receiving, from a third UE, a second sidelink message indicating the retransmission of the downlink data will be received from the second UE, where the third UE is a primary UE of the first UE group.

In some examples, the first subset of resources includes a set of subchannels that are associated with the second UE.

In some examples, each UE group of the one or more UE groups includes a set of multiple UEs and each UE of a UE group is configured with a downlink communication beam having a beam direction that is within a threshold beam direction with respect to other downlink communication beam directions of other UEs included in the UE group.

In some examples, the configuration further indicates a relative priority of each UE of a respective UE group, and the priority component 850 may be configured as or otherwise support a means for determining that the second UE has a higher priority than a third UE based on the configuration, where receiving the sidelink message via the first subset of resources from the second UE is based on the lower priority.

In some examples, the SCI component 840 may be configured as or otherwise support a means for decoding the sidelink control information communicated via the one or more subsets of resources indicated by the configuration.

In some examples, receiving the sidelink message via the first subset of resources during a time period precludes other UEs of the first UE group from communicating via the first subset of resources during the time period.

In some examples, the one or more UEs include a UE group that is associated with the first UE.

In some examples, each UE group of the one or more UE groups is associated with a single subset of resources.

Additionally, or alternatively, the communications manager 820 may support wireless communication at a first UE in accordance with examples as disclosed herein. In some examples, the monitoring configuration component 825 may be configured as or otherwise support a means for receiving a message indicating a configuration for monitoring one or more resources in accordance with a pattern of resources, the pattern of resources indicating an ordering of respective subchannels of a set of multiple subchannels for retransmissions of downlink data via a sidelink data channel. In some examples, the feedback component 830 may be configured as or otherwise support a means for broadcasting, to one or more UEs, a feedback message based on failing to decode a downlink transmission including the downlink data. In some examples, the resource monitoring component 835 may be configured as or otherwise support a means for monitoring, in accordance with the ordering, one or more subchannels of the set of multiple subchannels for sidelink control information based on the configuration and broadcasting the feedback message. In some examples, the SCI component 840 may be configured as or otherwise support a means for receiving, from a second UE, a sidelink message including the sidelink control information based on the monitoring, the sidelink control information indicating a sidelink data channel for a retransmission of the downlink data based on the feedback message.

In some examples, to support monitoring the one or more subchannels, the resource monitoring component 835 may be configured as or otherwise support a means for monitoring a first set of subchannels of the set of multiple subchannels according to the pattern. In some examples, to support monitoring the one or more subchannels, the SCI component 840 may be configured as or otherwise support a means for determining whether the first set of subchannels includes the sidelink control information based on the monitoring.

In some examples, the resource monitoring component 835 may be configured as or otherwise support a means for monitoring a second set of subchannels of the set of multiple subchannels according to the pattern based on an absence of the sidelink control information in the first set of subchannels.

In some examples, the SCI component 840 may be configured as or otherwise support a means for detecting the sidelink control information based on monitoring the second set of subchannels. In some examples, the SCI component 840 may be configured as or otherwise support a means for decoding the sidelink control information communicated via the second set of subchannels, where the first set of subchannels has a higher priority than the second set of subchannels.

In some examples, the SCI component 840 may be configured as or otherwise support a means for transmitting, to a third UE via the first set of subchannels or the second set of subchannels, a second sidelink message including second sidelink control information, the second sidelink control information indicating a second sidelink data channel for a retransmission of second downlink data.

In some examples, each subchannel of the set of multiple subchannels is associated with a respective priority relative to other subchannels of the set of multiple subchannels.

In some examples, a subchannel of the set of multiple subchannels is dedicated to sidelink communications associated with a threshold priority. In some examples, the one or more subchannels include remaining subchannels of the set of multiple subchannels.

Additionally, or alternatively, the communications manager 820 may support wireless communications at a first UE in accordance with examples as disclosed herein. In some examples, the monitoring configuration component 825 may be configured as or otherwise support a means for receiving a message indicating a configuration for transmissions using one or more subsets of resources from a resource pool, the one or more subsets of resources being associated with a respective UE group of one or more UE groups, where each UE group of the one or more UE groups includes at least one UE. In some examples, the feedback component 830 may be configured as or otherwise support a means for receiving, from a second UE, a feedback message indicating the second UE failed to decode a downlink transmission including downlink data. In some examples, the SCI component 840 may be configured as or otherwise support a means for transmitting, to the second UE via a first subset of resources, a sidelink message including sidelink control information based on the configuration and receiving the feedback message, the sidelink control information indicating a sidelink data channel for a retransmission of the downlink data, the first subset of resources corresponding to a first UE group that includes the second UE.

In some examples, the resource configuration component 855 may be configured as or otherwise support a means for determining, based on the configuration, which subset of the one or more subsets of resources is associated with the first UE, where transmitting the sidelink message includes. In some examples, the SCI component 840 may be configured as or otherwise support a means for transmitting the sidelink message via the determined subset of resources.

In some examples, to support transmitting the sidelink control information via the first subset of resources, the SCI component 840 may be configured as or otherwise support a means for transmitting the sidelink control information via a first subchannel associated with the second UE.

In some examples, transmitting the sidelink message via the first subset of resources during a time period precludes other UEs of the first UE group from communicating via the first subset of resources during the time period.

In some examples, the configuration further indicates a relative priority of each UE of a respective UE group, and the priority component 850 may be configured as or otherwise support a means for determining that the second UE has a higher priority than a third UE that failed to decode the downlink transmission based on the configuration, where transmitting the sidelink message via the first subset of resources to the second UE is based on the higher priority.

In some examples, the retransmission component 845 may be configured as or otherwise support a means for receiving, from a third UE, a second sidelink message indicating the retransmission of the downlink data will be transmitted by the first UE via a subset of resources associated with the first UE, where the third UE is a primary UE of the first UE group and transmitting the sidelink message is based on receiving the second sidelink message. In some examples, the retransmission component 845 may be configured as or otherwise support a means for transmitting, to the second UE, the sidelink data channel including the retransmission of the downlink data based on receiving the second sidelink message.

In some examples, the retransmission component 845 may be configured as or otherwise support a means for transmitting, to a third UE, a second sidelink message indicating the retransmission of the downlink data will be transmitted by the third UE, where the first UE is a primary UE of the first UE group.

In some examples, each UE group of the one or more UE groups is associated with a single subset of resources.

In some examples, the single subset of resources includes a single subchannel.

Additionally, or alternatively, the communications manager 820 may support wireless communication at a first UE in accordance with examples as disclosed herein. In some examples, the monitoring configuration component 825 may be configured as or otherwise support a means for receiving a message indicating a configuration for sidelink transmissions in accordance with a pattern of resources, the pattern of resources indicating an ordering of respective subchannels of a set of multiple subchannels for retransmissions of downlink data via a sidelink data channel. In some examples, the feedback component 830 may be configured as or otherwise support a means for receiving, from a second UE, a feedback message indicating the second UE failed to decode a downlink transmission including the downlink data. In some examples, the SCI component 840 may be configured as or otherwise support a means for transmitting, in response to receiving the feedback message and in accordance with the ordering, sidelink control information via one or more subchannels of the set of multiple subchannels based on receiving the feedback message and the configuration, the sidelink control information indicating a sidelink data channel for a retransmission of the downlink data. The retransmission component 845 may be configured as or otherwise support a means for transmitting, to the second UE, the sidelink data channel including the retransmission of the downlink data based on transmitting the sidelink control information.

In some examples, the resource sensing component 860 may be configured as or otherwise support a means for sensing a first subchannel of the set of multiple subchannels according the pattern. In some examples, the SCI component 840 may be configured as or otherwise support a means for determining whether the first subchannel is available for the retransmission, where transmitting the sidelink control information is based on the determining.

In some examples, the resource sensing component 860 may be configured as or otherwise support a means for sensing a second subchannel of the set of multiple subchannels according to the pattern based on determining the first subchannel is unavailable. In some examples, the SCI component 840 may be configured as or otherwise support a means for determining the second subchannel is available for the retransmission, where transmitting the sidelink control information is based on the determining.

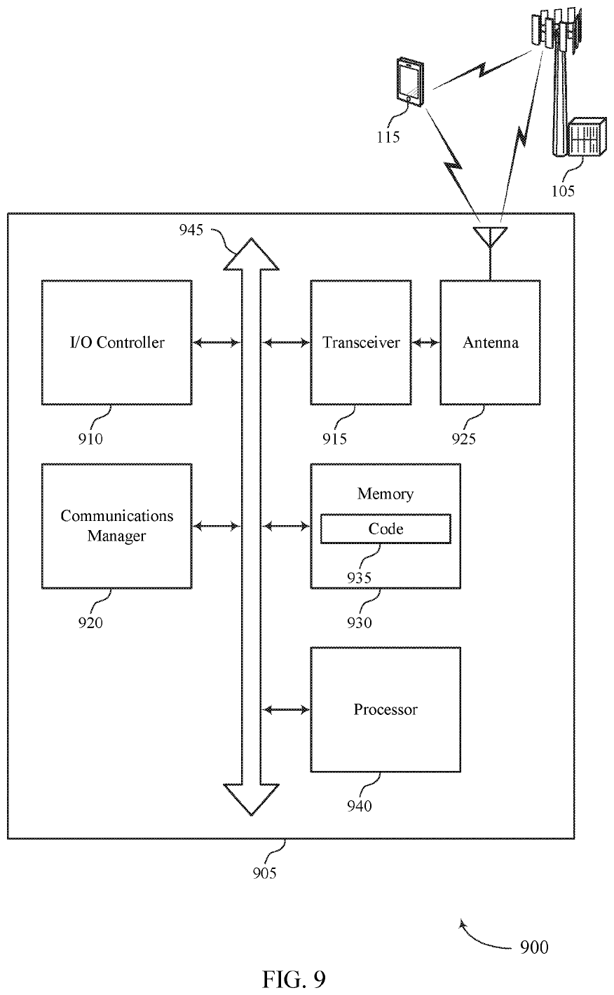

FIG. 9 shows a diagram of a system 900 including a device 905 that supports techniques for decoding sidelink control information for retransmissions in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for decoding sidelink control information for retransmissions). For example, the device 905 or a component of the device 905 may include a processor 940 and memory 930 coupled with or to the processor 940, the processor 940 and memory 930 configured to perform various functions described herein.

The communications manager 920 may support wireless communications at a first UE in accordance with examples as disclosed herein. For example, the communications manager 920 may be configured as or otherwise support a means for receiving a message indicating a configuration for monitoring one or more subsets of resources from a resource pool, the one or more subsets of resources being associated with a respective UE group of one or more UE groups. The communications manager 920 may be configured as or otherwise support a means for broadcasting, to two or more UEs, a feedback message based at least in part on failing to decode a downlink transmission including downlink data. The communications manager 920 may be configured as or otherwise support a means for monitoring a first subset of resources of the one or more subsets of resources for sidelink control information based on the configuration and broadcasting the feedback message. The communications manager 920 may be configured as or otherwise support a means for receiving, from a second UE and via the first subset of resources, a sidelink message including the sidelink control information based on the monitoring, the sidelink control information indicating a sidelink data channel for a retransmission of the downlink data based on the feedback message, the first subset of resources corresponding to a first UE group that includes the second UE.

Additionally, or alternatively, the communications manager 920 may support wireless communication at a first UE in accordance with examples as disclosed herein. For example, the communications manager 920 may be configured as or otherwise support a means for receiving a message indicating a configuration for monitoring one or more resources in accordance with a pattern of resources, the pattern of resources indicating an ordering of respective subchannels of a set of multiple subchannels for retransmissions of downlink data via a sidelink data channel. The communications manager 920 may be configured as or otherwise support a means for broadcasting, to one or more UEs, a feedback message based at least in part on failing to decode a downlink transmission including the downlink data. The communications manager 920 may be configured as or otherwise support a means for monitoring, in accordance with the ordering, one or more subchannels of the set of multiple subchannels for sidelink control information based on the configuration and broadcasting the feedback message. The communications manager 920 may be configured as or otherwise support a means for receiving, from a second UE, a sidelink message including the sidelink control information based on the monitoring, the sidelink control information indicating a sidelink data channel for a retransmission of the downlink data based on the feedback message.

Additionally, or alternatively, the communications manager 920 may support wireless communications at a first UE in accordance with examples as disclosed herein. For example, the communications manager 920 may be configured as or otherwise support a means for receiving a message indicating a configuration for transmissions using one or more subsets of resources from a resource pool, the one or more subsets of resources being associated with a respective UE group of one or more UE groups, where each UE group of the one or more UE groups includes at least one UE. The communications manager 920 may be configured as or otherwise support a means for receiving, from a second UE, a feedback message indicating the second UE failed to decode a downlink transmission including downlink data. The communications manager 920 may be configured as or otherwise support a means for transmitting, to the second UE via a first subset of resources, a sidelink message including sidelink control information based on the configuration and receiving the feedback message, the sidelink control information indicating a sidelink data channel for a retransmission of the downlink data, the first subset of resources corresponding to a first UE group that includes the second UE.

Additionally, or alternatively, the communications manager 920 may support wireless communication at a first UE in accordance with examples as disclosed herein. For example, the communications manager 920 may be configured as or otherwise support a means for receiving a message indicating a configuration for sidelink transmissions in accordance with a pattern of resources, the pattern of resources indicating an ordering of respective subchannels of a set of multiple subchannels for retransmissions of downlink data via a sidelink data channel. The communications manager 920 may be configured as or otherwise support a means for receiving, from a second UE, a feedback message indicating the second UE failed to decode a downlink transmission including the downlink data. The communications manager 920 may be configured as or otherwise support a means for transmitting, in response to receiving the feedback message and in accordance with the ordering, sidelink control information via one or more subchannels of the set of multiple subchannels based on receiving the feedback message and the configuration, the sidelink control information indicating a sidelink data channel for a retransmission of the downlink data. The communications manager 920 may be configured as or otherwise support a means for transmitting, to the second UE, the sidelink data channel including the retransmission of the downlink data based on transmitting the sidelink control information.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, and longer battery life, among other examples.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for decoding sidelink control information for retransmissions as described herein, or the processor 940 and the memory 930 may be otherwise configured to perform or support such operations.

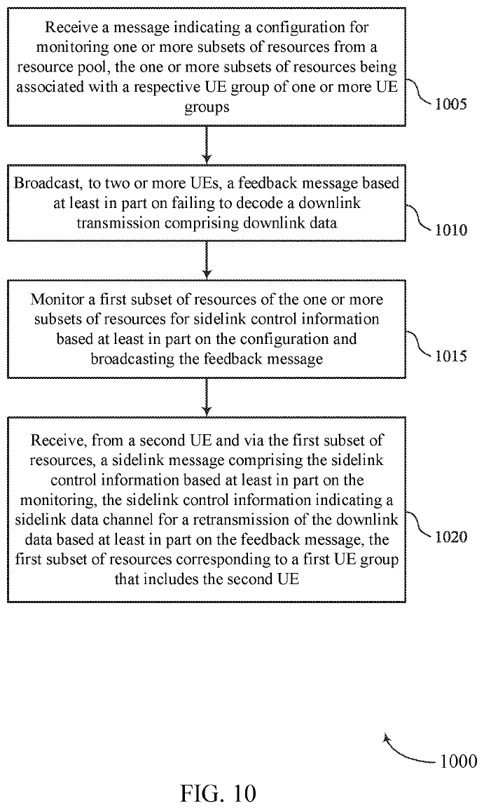

FIG. 10 shows a flowchart illustrating a method 1000 that supports techniques for decoding sidelink control information for retransmissions in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving a message indicating a configuration for monitoring one or more subsets of resources from a resource pool, the one or more subsets of resources being associated with a respective UE group of one or more UE groups. The operations of 1005 may be performed in accordance with examples as disclosed herein. In some examples, aspects of the operations of 1005 may be performed by a monitoring configuration component 825 as described with reference to FIG. 8.

At 1010, the method may include broadcasting, to two or more UEs, a feedback message based on failing to decode a downlink transmission including downlink data. The operations of 1010 may be performed in accordance with examples as disclosed herein. In some examples, aspects of the operations of 1010 may be performed by a feedback component 830 as described with reference to FIG. 8.

At 1015, the method may include monitoring a first subset of resources of the one or more subsets of resources for sidelink control information based on the configuration and broadcasting the feedback message. The operations of 1015 may be performed in accordance with examples as disclosed herein. In some examples, aspects of the operations of 1015 may be performed by a resource monitoring component 835 as described with reference to FIG. 8.

At 1020, the method may include receiving, from a second UE and via the first subset of resources, a sidelink message including the sidelink control information based on the monitoring, the sidelink control information indicating a sidelink data channel for a retransmission of the downlink data based on the feedback message, the first subset of resources corresponding to a first UE group that includes the second UE. The operations of 1020 may be performed in accordance with examples as disclosed herein. In some examples, aspects of the operations of 1020 may be performed by an SCI component 840 as described with reference to FIG. 8.

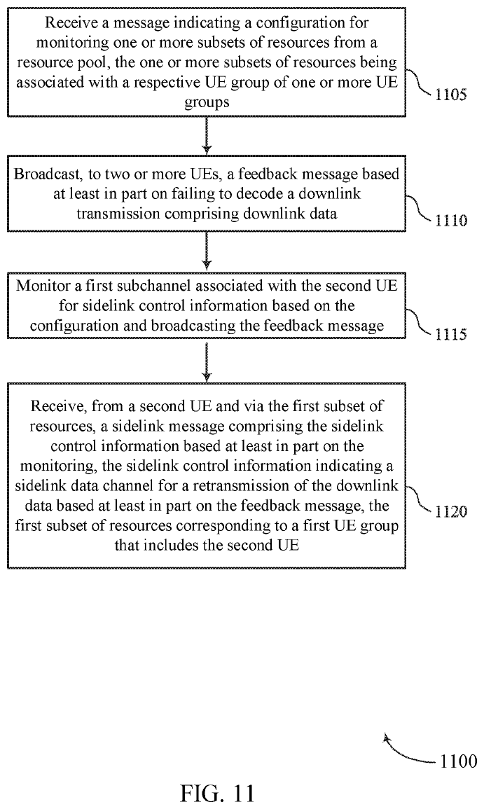

FIG. 11 shows a flowchart illustrating a method 1100 that supports techniques for decoding sidelink control information for retransmissions in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving a message indicating a configuration for monitoring one or more subsets of resources from a resource pool, the one or more subsets of resources being associated with a respective UE group of one or more UE groups. The operations of 1105 may be performed in accordance with examples as disclosed herein. In some examples, aspects of the operations of 1105 may be performed by a monitoring configuration component 825 as described with reference to FIG. 8.

At 1110, the method may include broadcasting, to two or more UEs, a feedback message based on failing to decode a downlink transmission including downlink data. The operations of 1110 may be performed in accordance with examples as disclosed herein. In some examples, aspects of the operations of 1110 may be performed by a feedback component 830 as described with reference to FIG. 8.

At 1115, the method may include monitoring a first subchannel associated with the second UE for sidelink control information based on the configuration and broadcasting the feedback message. The operations of 1115 may be performed in accordance with examples as disclosed herein. In some examples, aspects of the operations of 1115 may be performed by a resource monitoring component 835 as described with reference to FIG. 8.

At 1120, the method may include receiving, from a second UE and via the first subset of resources, a sidelink message including the sidelink control information based on the monitoring, the sidelink control information indicating a sidelink data channel for a retransmission of the downlink data based on the feedback message, the first subset of resources corresponding to a first UE group that includes the second UE. The operations of 1120 may be performed in accordance with examples as disclosed herein. In some examples, aspects of the operations of 1120 may be performed by an SCI component 840 as described with reference to FIG. 8.

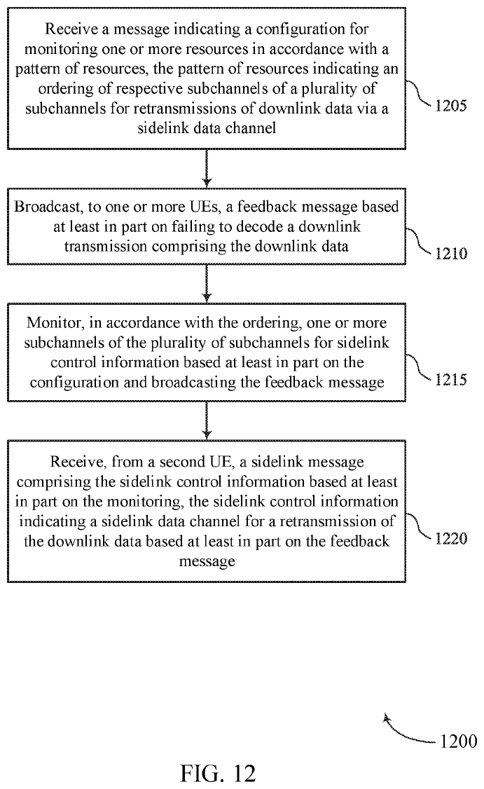

FIG. 12 shows a flowchart illustrating a method 1200 that supports techniques for decoding sidelink control information for retransmissions in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving a message indicating a configuration for monitoring one or more resources in accordance with a pattern of resources, the pattern of resources indicating an ordering of respective subchannels of a set of multiple subchannels for retransmissions of downlink data via a sidelink data channel. The operations of 1205 may be performed in accordance with examples as disclosed herein. In some examples, aspects of the operations of 1205 may be performed by a monitoring configuration component 825 as described with reference to FIG. 8.

At 1210, the method may include broadcasting, to one or more UEs, a feedback message based on failing to decode a downlink transmission including the downlink data. The operations of 1210 may be performed in accordance with examples as disclosed herein. In some examples, aspects of the operations of 1210 may be performed by a feedback component 830 as described with reference to FIG. 8.

At 1215, the method may include monitoring, in accordance with the ordering, one or more subchannels of the set of multiple subchannels for sidelink control information based on the configuration and broadcasting the feedback message. The operations of 1215 may be performed in accordance with examples as disclosed herein. In some examples, aspects of the operations of 1215 may be performed by a resource monitoring component 835 as described with reference to FIG. 8.

At 1220, the method may include receiving, from a second UE, a sidelink message including the sidelink control information based on the monitoring, the sidelink control information indicating a sidelink data channel for a retransmission of the downlink data based on the feedback message. The operations of 1220 may be performed in accordance with examples as disclosed herein. In some examples, aspects of the operations of 1220 may be performed by an SCI component 840 as described with reference to FIG. 8.

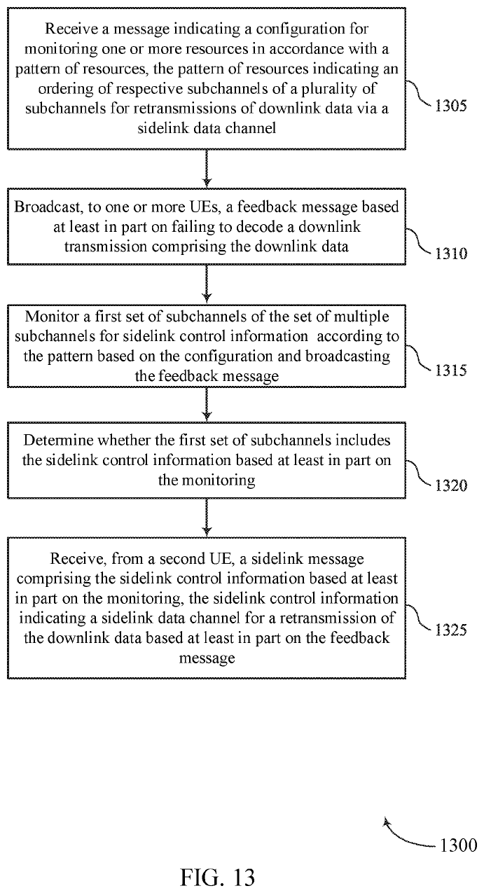

FIG. 13 shows a flowchart illustrating a method 1300 that supports techniques for decoding sidelink control information for retransmissions in accordance with one or more aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include receiving a message indicating a configuration for monitoring one or more resources in accordance with a pattern of resources, the pattern of resources indicating an ordering of respective subchannels of a set of multiple subchannels for retransmissions of downlink data via a sidelink data channel. The operations of 1305 may be performed in accordance with examples as disclosed herein. In some examples, aspects of the operations of 1305 may be performed by a monitoring configuration component 825 as described with reference to FIG. 8.

At 1310, the method may include broadcasting, to one or more UEs, a feedback message based on failing to decode a downlink transmission including the downlink data. The operations of 1310 may be performed in accordance with examples as disclosed herein. In some examples, aspects of the operations of 1310 may be performed by a feedback component 830 as described with reference to FIG. 8.

At 1315, the method may include monitoring a first set of subchannels of the set of multiple subchannels for sidelink control information according to the pattern based on the configuration and broadcasting the feedback message. The operations of 1315 may be performed in accordance with examples as disclosed herein. In some examples, aspects of the operations of 1315 may be performed by a resource monitoring component 835 as described with reference to FIG. 8.

At 1320, the method may include determining whether the first set of subchannels includes the sidelink control information based on the monitoring. The operations of 1320 may be performed in accordance with examples as disclosed herein. In some examples, aspects of the operations of 1320 may be performed by an SCI component 840 as described with reference to FIG. 8.

At 1325, the method may include receiving, from a second UE, a sidelink message including the sidelink control information based on the monitoring, the sidelink control information indicating a sidelink data channel for a retransmission of the downlink data based on the feedback message. The operations of 1325 may be performed in accordance with examples as disclosed herein. In some examples, aspects of the operations of 1325 may be performed by an SCI component 840 as described with reference to FIG. 8.

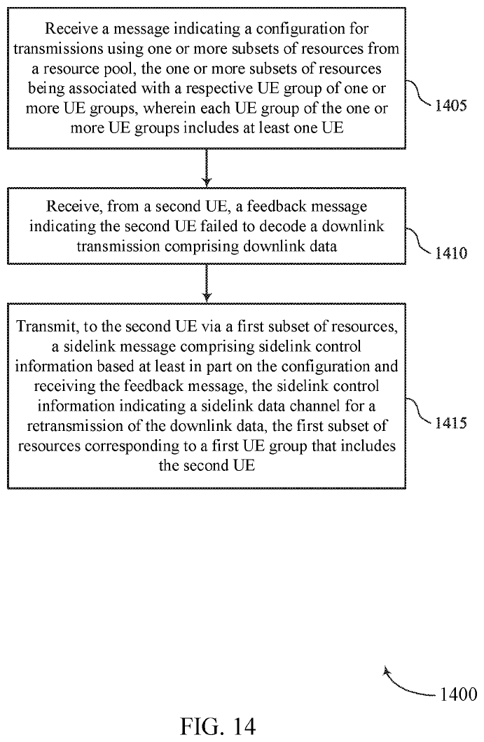

FIG. 14 shows a flowchart illustrating a method 1400 that supports techniques for decoding sidelink control information for retransmissions in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a message indicating a configuration for transmissions using one or more subsets of resources from a resource pool, the one or more subsets of resources being associated with a respective UE group of one or more UE groups, where each UE group of the one or more UE groups includes at least one UE. The operations of 1405 may be performed in accordance with examples as disclosed herein. In some examples, aspects of the operations of 1405 may be performed by a monitoring configuration component 825 as described with reference to FIG. 8.

At 1410, the method may include receiving, from a second UE, a feedback message indicating the second UE failed to decode a downlink transmission including downlink data. The operations of 1410 may be performed in accordance with examples as disclosed herein. In some examples, aspects of the operations of 1410 may be performed by a feedback component 830 as described with reference to FIG. 8.

At 1415, the method may include transmitting, to the second UE via a first subset of resources, a sidelink message including sidelink control information based on the configuration and receiving the feedback message, the sidelink control information indicating a sidelink data channel for a retransmission of the downlink data, the first subset of resources corresponding to a first UE group that includes the second UE. The operations of 1415 may be performed in accordance with examples as disclosed herein. In some examples, aspects of the operations of 1415 may be performed by an SCI component 840 as described with reference to FIG. 8.

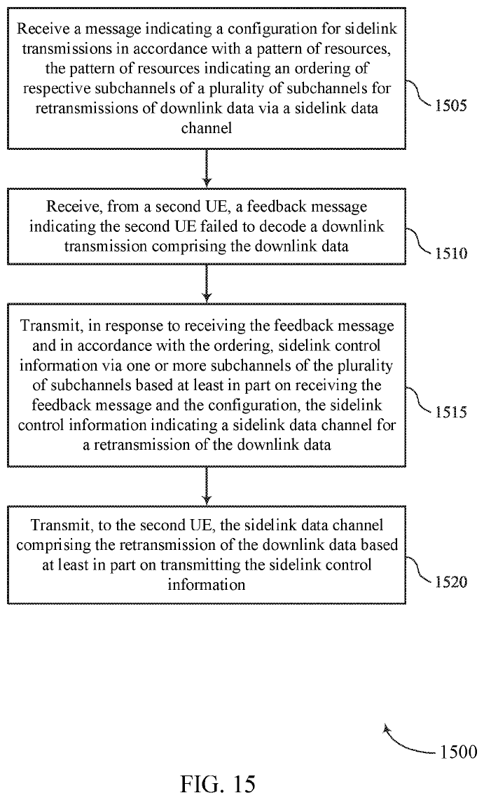

FIG. 15 shows a flowchart illustrating a method 1500 that supports techniques for decoding sidelink control information for retransmissions in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a message indicating a configuration for sidelink transmissions in accordance with a pattern of resources, the pattern of resources indicating an ordering of respective subchannels of a set of multiple subchannels for retransmissions of downlink data via a sidelink data channel. The operations of 1505 may be performed in accordance with examples as disclosed herein. In some examples, aspects of the operations of 1505 may be performed by a monitoring configuration component 825 as described with reference to FIG. 8.

At 1510, the method may include receiving, from a second UE, a feedback message indicating the second UE failed to decode a downlink transmission including the downlink data. The operations of 1510 may be performed in accordance with examples as disclosed herein. In some examples, aspects of the operations of 1510 may be performed by a feedback component 830 as described with reference to FIG. 8.

At 1515, the method may include transmitting, in response to receiving the feedback message and in accordance with the ordering, sidelink control information via one or more subchannels of the set of multiple subchannels based on receiving the feedback message and the configuration, the sidelink control information indicating a sidelink data channel for a retransmission of the downlink data. The operations of 1515 may be performed in accordance with examples as disclosed herein. In some examples, aspects of the operations of 1515 may be performed by an SCI component 840 as described with reference to FIG. 8.

At 1520, the method may include transmitting, to the second UE, the sidelink data channel including the retransmission of the downlink data based on transmitting the sidelink control information. The operations of 1520 may be performed in accordance with examples as disclosed herein. In some examples, aspects of the operations of 1520 may be performed by a retransmission component 845 as described with reference to FIG. 8.

The following provides an overview of aspects of the present disclosure:

Aspect 1: A method for wireless communications at a first UE, comprising: receiving a message indicating a configuration for monitoring one or more subsets of resources from a resource pool, the one or more subsets of resources being associated with a respective UE group of one or more UE groups; broadcasting, to two or more UEs, a feedback message based at least in part on failing to decode a downlink transmission comprising downlink data; monitoring a first subset of resources of the one or more subsets of resources for sidelink control information based at least in part on the configuration and broadcasting the feedback message; and receiving, from a second UE and via the first subset of resources, a sidelink message comprising the sidelink control information based at least in part on the monitoring, the sidelink control information indicating a sidelink data channel for a retransmission of the downlink data based at least in part on the feedback message, the first subset of resources corresponding to a first UE group that includes the second UE.

Aspect 2: The method of aspect 1, wherein the resource pool comprises a plurality of subchannels and each UE of the first UE group is associated with a respective subset of resources comprising a subchannel of the plurality of subchannels, wherein monitoring the first subset of resources comprises: monitoring a first subchannel associated with the second UE for the sidelink control information.

Aspect 3: The method of aspect 2, wherein the configuration further indicates a mapping between each UE of the first UE group and a respective subchannel of the plurality of subchannels, and receiving the sidelink message is based at least in part on the mapping.

Aspect 4: The method of any of aspects 1 through 3, further comprising: receiving, from a third UE, a second sidelink message indicating the retransmission of the downlink data will be received from the second UE, wherein the third UE comprises a primary UE of the first UE group.

Aspect 5: The method of aspect 4, wherein the first subset of resources comprises a set of subchannels that are associated with the second UE.

Aspect 6: The method of any of aspects 1 through 5, wherein each UE group of the one or more UE groups comprises a plurality of UEs and each UE of a UE group is configured with a downlink communication beam having a beam direction that is within a threshold beam direction with respect to other downlink communication beam directions of other UEs included in the UE group.

Aspect 7: The method of any of aspects 1 through 6, wherein the configuration further indicates a relative priority of each UE of a respective UE group, the method further comprising: determining that the second UE has a higher priority than a third UE based at least in part on the configuration, wherein receiving the sidelink message via the first subset of resources from the second UE is based at least in part on the higher priority.

Aspect 8: The method of any of aspects 1 through 7, further comprising: decoding the sidelink control information communicated via the one or more subsets of resources indicated by the configuration.

Aspect 9: The method of any of aspects 1 through 8, wherein receiving the sidelink message via the first subset of resources during a time period precludes other UEs of the first UE group from communicating via the first subset of resources during the time period.

Aspect 10: The method of any of aspects 1 through 9, wherein the two or more UEs comprise a UE group that is associated with the first UE.

Aspect 11: The method of any of aspects 7 through 10, wherein each UE group of the one or more UE groups is associated with a single subset of resources.

Aspect 12: A method for wireless communication at a first UE, comprising: receiving a message indicating a configuration for monitoring one or more resources in accordance with a pattern of resources, the pattern of resources indicating an ordering of respective subchannels of a plurality of subchannels for retransmissions of downlink data via a sidelink data channel; broadcasting, to two or more UEs, a feedback message based at least in part on failing to decode a downlink transmission comprising the downlink data; monitoring, in accordance with the ordering, one or more subchannels of the plurality of subchannels for sidelink control information based at least in part on the configuration and broadcasting the feedback message; and receiving, from a second UE, a sidelink message comprising the sidelink control information based at least in part on the monitoring, the sidelink control information indicating a sidelink data channel for a retransmission of the downlink data based at least in part on the feedback message.

Aspect 13: The method of aspect 12, wherein monitoring the one or more subchannels comprises: monitoring a first set of subchannels of the plurality of subchannels according to the pattern; and determining whether the first set of subchannels includes the sidelink control information based at least in part on the monitoring.

Aspect 14: The method of aspect 13, further comprising: monitoring a second set of subchannels of the plurality of subchannels according to the pattern based at least in part on an absence of the sidelink control information in the first set of subchannels.

Aspect 15: The method of aspect 14, further comprising: detecting the sidelink control information based at least in part on monitoring the second set of subchannels; and decoding the sidelink control information communicated via the second set of subchannels, wherein the first set of subchannels has a higher priority than the second set of subchannels.

Aspect 16: The method of aspect 15, further comprising: transmitting, to a third UE via the first set of subchannels or the second set of subchannels, a second sidelink message comprising second sidelink control information, the second sidelink control information indicating a second sidelink data channel for a retransmission of second downlink data.

Aspect 17: The method of any of aspects 12 through 16, wherein each subchannel of the plurality of subchannels is associated with a respective priority relative to other subchannels of the plurality of subchannels.

Aspect 18: The method of aspect 17, wherein a subchannel of the plurality of subchannels is dedicated to sidelink communications associated with a threshold priority, and the one or more subchannels comprise remaining subchannels of the plurality of subchannels.

Aspect 19: A method for wireless communications at a first UE, comprising: receiving a message indicating a configuration for transmissions using one or more subsets of resources from a resource pool, the one or more subsets of resources being associated with a respective UE group of one or more UE groups; receiving, from a second UE, a feedback message indicating the second UE failed to decode a downlink transmission comprising downlink data; and transmitting, to the second UE via a first subset of resources, a sidelink message comprising sidelink control information based at least in part on the configuration and receiving the feedback message, the sidelink control information indicating a sidelink data channel for a retransmission of the downlink data, the first subset of resources corresponding to a first UE group that includes the second UE.

Aspect 20: The method of aspect 19, further comprising: determining, based at least in part on the configuration, which subset of the one or more subsets of resources is associated with the first UE, wherein transmitting the sidelink message comprises: transmitting the sidelink message via the determined subset of resources.

Aspect 21: The method of any of aspect 19 through 20, wherein the resource pool comprises a plurality of subchannels and each UE of the respective UE group is associated with a respective subset of resources comprising a subchannel of the plurality of subchannels, wherein transmitting the sidelink control information via the first subset of resources comprises: transmitting the sidelink control information via a first subchannel associated with the second UE.

Aspect 22: The method of any of aspect 19, wherein transmitting the sidelink message via the first subset of resources during a time period precludes other UEs of the first UE group from communicating via the first subset of resources during the time period.

Aspect 23: The method of any of aspects 19 and 22, wherein the configuration further indicates a relative priority of each UE of a respective UE group, the method further comprising: determining that the second UE has a higher priority than a third UE that failed to decode the downlink transmission based at least in part on the configuration, wherein transmitting the sidelink message via the first subset of resources to the second UE is based at least in part on the higher priority.

Aspect 24: The method of any of aspects 19 through 21, further comprising: receiving, from a third UE, a second sidelink message indicating the retransmission of the downlink data will be transmitted by the first UE via a subset of resources associated with the first UE, wherein the third UE is a primary UE of the first UE group and transmitting the sidelink message is based at least in part on receiving the second sidelink message; and transmitting, to the second UE, the sidelink data channel comprising the retransmission of the downlink data based at least in part on receiving the second sidelink message.

Aspect 25: The method of any of aspects 19 through 21 and 24, further comprising: transmitting, to a third UE, a second sidelink message indicating the retransmission of the downlink data will be transmitted by the third UE, wherein the first UE is a primary UE of the first UE group.

Aspect 26: The method of any of aspects 19, 22, and 23, wherein each UE group of the one or more UE groups is associated with a single subset of resources.

Aspect 27: The method of aspect 26, wherein the single subset of resources comprises a single subchannel.

Aspect 28: A method for wireless communication at a first UE, comprising: receiving a message indicating a configuration for sidelink transmissions in accordance with a pattern of resources, the pattern of resources indicating an ordering of respective subchannels of a plurality of subchannels for retransmissions of downlink data via a sidelink data channel; receiving, from a second UE, a feedback message indicating the second UE failed to decode a downlink transmission comprising the downlink data; transmitting, in response to receiving the feedback message and in accordance with the ordering, sidelink control information via one or more subchannels of the plurality of subchannels based at least in part on receiving the feedback message and the configuration, the sidelink control information indicating a sidelink data channel for a retransmission of the downlink data; and transmitting, to the second UE, the sidelink data channel comprising the retransmission of the downlink data based at least in part on transmitting the sidelink control information.

Aspect 29: The method of aspect 28, further comprising: sensing a first subchannel of the plurality of subchannels according the pattern; and determining whether the first subchannel is available for the retransmission, wherein transmitting the sidelink control information is based at least in part on the determining.

Aspect 30: The method of aspect 29, further comprising: sensing a second subchannel of the plurality of subchannels according to the pattern based at least in part on determining the first subchannel is unavailable; and determining the second subchannel is available for the retransmission, wherein transmitting the sidelink control information is based at least in part on the determining.

Aspect 31: An apparatus for wireless communications at a first UE, comprising a processor; memory coupled with the processor; and instructions stored in the memory and executable by the processor to cause the apparatus to perform a method of any of aspects 1 through 11.

Aspect 32: An apparatus for wireless communications at a first UE, comprising at least one means for performing a method of any of aspects 1 through 11.

Aspect 33: A non-transitory computer-readable medium storing code for wireless communications at a first UE, the code comprising instructions executable by a processor to perform a method of any of aspects 1 through 11.

Aspect 34: An apparatus for wireless communication at a first UE, comprising a processor; memory coupled with the processor; and instructions stored in the memory and executable by the processor to cause the apparatus to perform a method of any of aspects 12 through 18.

Aspect 35: An apparatus for wireless communication at a first UE, comprising at least one means for performing a method of any of aspects 12 through 18.

Aspect 36: A non-transitory computer-readable medium storing code for wireless communication at a first UE, the code comprising instructions executable by a processor to perform a method of any of aspects 12 through 18.

Aspect 37: An apparatus for wireless communications at a first UE, comprising a processor; memory coupled with the processor; and instructions stored in the memory and executable by the processor to cause the apparatus to perform a method of any of aspects 19 through 27.

Aspect 38: An apparatus for wireless communications at a first UE, comprising at least one means for performing a method of any of aspects 19 through 27.

Aspect 39: A non-transitory computer-readable medium storing code for wireless communications at a first UE, the code comprising instructions executable by a processor to perform a method of any of aspects 19 through 27.

Aspect 40: An apparatus for wireless communication at a first UE, comprising a processor; memory coupled with the processor; and instructions stored in the memory and executable by the processor to cause the apparatus to perform a method of any of aspects 28 through 30.

Aspect 41: An apparatus for wireless communication at a first UE, comprising at least one means for performing a method of any of aspects 28 through 30.

Aspect 42: A non-transitory computer-readable medium storing code for wireless communication at a first UE, the code comprising instructions executable by a processor to perform a method of any of aspects 28 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first user equipment (UE), comprising:
receiving a message indicating a configuration for monitoring one or more subsets of resources from a resource pool, the one or more subsets of resources being associated with a respective UE group of one or more UE groups;
broadcasting, to two or more UEs, a feedback message based at least in part on failing to decode a downlink transmission comprising downlink data;
monitoring a first subset of resources of the one or more subsets of resources for sidelink control information based at least in part on the configuration and broadcasting the feedback message; and
receiving, from a second UE and via the first subset of resources, a sidelink message comprising the sidelink control information based at least in part on the monitoring, the sidelink control information indicating a sidelink data channel for a retransmission of the downlink data based at least in part on the feedback message, the first subset of resources corresponding to a first UE group that includes the second UE.

2. The method of claim 1, wherein the resource pool comprises a plurality of subchannels and each UE of the first UE group is associated with a respective subset of resources comprising a subchannel of the plurality of subchannels, wherein monitoring the first subset of resources comprises:
monitoring a first subchannel associated with the second UE for the sidelink control information.

3. The method of claim 2, wherein:
the configuration further indicates a mapping between each UE of the first UE group and a respective subchannel of the plurality of subchannels, and
receiving the sidelink message is based at least in part on the mapping.

4. The method of claim 1, further comprising:
receiving, from a third UE, a second sidelink message indicating the retransmission of the downlink data will be received from the second UE, wherein the third UE comprises a primary UE of the first UE group.

5. The method of claim 4, wherein the first subset of resources comprises a set of subchannels that are associated with the second UE.

6. The method of claim 1, wherein each UE group of the one or more UE groups comprises a plurality of UEs and each UE of a UE group is configured with a downlink communication beam having a beam direction that is within a threshold beam direction with respect to other downlink communication beam directions of other UEs included in the UE group.

7. The method of claim 1, wherein the configuration further indicates a relative priority of each UE of a respective UE group, the method further comprising:
determining that the second UE has a higher priority than a third UE based at least in part on the configuration, wherein receiving the sidelink message via the first subset of resources from the second UE is based at least in part on the higher priority.

8. The method of claim 1, further comprising:
decoding the sidelink control information communicated via the one or more subsets of resources indicated by the configuration.

9. The method of claim 1, wherein receiving the sidelink message via the first subset of resources during a time period precludes other UEs of the first UE group from communicating via the first subset of resources during the time period.

10. The method of claim 1, wherein the two or more UEs comprise a UE group that is associated with the first UE.

11. The method of claim 1, wherein each UE group of the one or more UE groups is associated with a single subset of resources.

12. A method for wireless communication at a first user equipment (UE), comprising:
receiving a message indicating a configuration for monitoring one or more resources in accordance with a pattern of resources, the pattern of resources indicating an ordering of respective subchannels of a plurality of subchannels for retransmissions of downlink data via a sidelink data channel;
broadcasting, to two or more UEs, a feedback message based at least in part on failing to decode a downlink transmission comprising the downlink data;
monitoring, in accordance with the ordering, one or more subchannels of the plurality of subchannels for sidelink control information based at least in part on the configuration and broadcasting the feedback message; and
receiving, from a second UE, a sidelink message comprising the sidelink control information based at least in part on the monitoring, the sidelink control information indicating a sidelink data channel for a retransmission of the downlink data based at least in part on the feedback message.

13. The method of claim 12, wherein monitoring the one or more subchannels comprises:
monitoring a first set of subchannels of the plurality of subchannels according to the pattern; and
determining whether the first set of subchannels includes the sidelink control information based at least in part on the monitoring.

14. The method of claim 13, further comprising:
monitoring a second set of subchannels of the plurality of subchannels according to the pattern based at least in part on an absence of the sidelink control information in the first set of subchannels.

15. The method of claim 14, further comprising:
detecting the sidelink control information based at least in part on monitoring the second set of subchannels; and
decoding the sidelink control information communicated via the second set of subchannels, wherein the first set of subchannels has a higher priority than the second set of subchannels.

16. The method of claim 15, further comprising:
transmitting, to a third UE via the first set of subchannels or the second set of subchannels, a second sidelink message comprising second sidelink control information, the second sidelink control information indicating a second sidelink data channel for a retransmission of second downlink data.

17. The method of claim 12, wherein each subchannel of the plurality of subchannels is associated with a respective priority relative to other subchannels of the plurality of subchannels.

18. The method of claim 17, wherein:
a subchannel of the plurality of subchannels is dedicated to sidelink communications associated with a threshold priority, and
the one or more subchannels comprise remaining subchannels of the plurality of subchannels.

19. A method for wireless communications at a first user equipment (UE), comprising:
receiving a message indicating a configuration for transmissions using one or more subsets of resources from a resource pool, the one or more subsets of resources being associated with a respective UE group of one or more UE groups;
receiving, from a second UE, a feedback message indicating the second UE failed to decode a downlink transmission comprising downlink data; and
transmitting, to the second UE via a first subset of resources, a sidelink message comprising sidelink control information based at least in part on the configuration and receiving the feedback message, the sidelink control information indicating a sidelink data channel for a retransmission of the downlink data, the first subset of resources corresponding to a first UE group that includes the second UE.

20. The method of claim 19, further comprising:
determining, based at least in part on the configuration, which subset of the one or more subsets of resources is associated with the first UE, wherein transmitting the sidelink message comprises:
transmitting the sidelink message via the determined subset of resources.

21. The method of claim 19, wherein the resource pool comprises a plurality of subchannels and each UE of the respective UE group is associated with a respective subset of resources comprising a subchannel of the plurality of subchannels, wherein transmitting the sidelink control information via the first subset of resources comprises:
transmitting the sidelink control information via a first subchannel associated with the second UE.

22. The method of claim 19, wherein transmitting the sidelink message via the first subset of resources during a time period precludes other UEs of the first UE group from communicating via the first subset of resources during the time period.

23. The method of claim 19, wherein the configuration further indicates a relative priority of each UE of a respective UE group, the method further comprising:
determining that the second UE has a higher priority than a third UE that failed to decode the downlink transmission based at least in part on the configuration, wherein transmitting the sidelink message via the first subset of resources to the second UE is based at least in part on the higher priority.

24. The method of claim 19, further comprising:
receiving, from a third UE, a second sidelink message indicating the retransmission of the downlink data will be transmitted by the first UE via a subset of resources associated with the first UE, wherein the third UE is a primary UE of the first UE group and transmitting the sidelink message is based at least in part on receiving the second sidelink message; and
transmitting, to the second UE, the sidelink data channel comprising the retransmission of the downlink data based at least in part on receiving the second sidelink message.

25. The method of claim 19, further comprising:
transmitting, to a third UE, a second sidelink message indicating the retransmission of the downlink data will be transmitted by the third UE, wherein the first UE is a primary UE of the first UE group.

26. The method of claim 19, wherein each UE group of the one or more UE groups is associated with a single subset of resources.

27. The method of claim 26, wherein the single subset of resources comprises a single subchannel.

28. A method for wireless communication at a first user equipment (UE), comprising:
receiving a message indicating a configuration for sidelink transmissions in accordance with a pattern of resources, the pattern of resources indicating an ordering of respective subchannels of a plurality of subchannels for retransmissions of downlink data via a sidelink data channel;
receiving, from a second UE, a feedback message indicating the second UE failed to decode a downlink transmission comprising the downlink data;
transmitting, in response to receiving the feedback message and in accordance with the ordering, sidelink control information via one or more subchannels of the plurality of subchannels based at least in part on receiving the feedback message and the configuration, the sidelink control information indicating a sidelink data channel for a retransmission of the downlink data; and
transmitting, to the second UE, the sidelink data channel comprising the retransmission of the downlink data based at least in part on transmitting the sidelink control information.

29. The method of claim 28, further comprising:
sensing a first subchannel of the plurality of subchannels according the pattern; and
determining whether the first subchannel is available for the retransmission, wherein transmitting the sidelink control information is based at least in part on the determining.

30. The method of claim 29, further comprising:
sensing a second subchannel of the plurality of subchannels according to the pattern based at least in part on determining the first subchannel is unavailable; and
determining the second subchannel is available for the retransmission, wherein transmitting the sidelink control information is based at least in part on the determining.
